(19) United States
(12) Patent Application Publication
(10) Pub. No.: US 2024/0410997 A1
(43) Pub. Date: Dec. 12, 2024

(54) DISTANCE-MEASUREMENT APPARATUS AND DISTANCE- MEASUREMENT METHOD

(71) Applicant: NEC Corporation, Minato-ku, Tokyo (JP)

(72) Inventor: Hidemi NOGUCHI, Tokyo (JP)

(73) Assignee: NEC Corporation, Minato-ku, Tokyo (JP)

(21) Appl. No.: 18/701,996

(22) PCT Filed: Nov. 5, 2021
(86) PCT No.: PCT/JP2021/040723

§ 371 Date: Apr. 17, 2024

(51) Int. Cl. G01S 7/487; G01S 7/4865; G01S 17/26

(52) U.S. Cl. CPC G01S 7/4876; G01S 7/4865; G01S 17/26

(57) ABSTRACT

Provided is a distance-measurement apparatus capable of preventing incorrect distance measurement. A generation unit generates a plurality of transmission pulses having frequency offsets different from each other. A transmission unit repeatedly transmits the transmission pulses generated by the generation unit. The reception unit receives reflected pulses of the respective transmission pulses reflected on a distance-measurement-target object. A detection unit detects frequency offsets of the reflected pulses received by the reception unit. A distance calculation unit calculates a distance to the distance-measurement-target object based on receiving timings of the reflected pulses received by the reception unit and transmitting timings of the transmission pulses corresponding to the frequency offsets detected from the reflected pulses. An invalidation processing unit performs processing of invalidating distance calculation processing for a certain period based on the transmitting timings of the transmission pulses.

### TECHNICAL FIELD

The present invention relates to a distance-measurement apparatus and a distance-measurement method, and more particularly, to a distance-measurement apparatus and a distance-measurement method for measuring a distance by transmitting a pulse and receiving its reflection.

### BACKGROUND ART

As a method for measuring a distance to a distance-measurement-target object, i.e., an object to which a distance is to be measured, there is a time-of-flight (Time of Flight: ToF) method. In the ToF method, a distance to a distance-measurement-target object, i.e., an object to which a distance is to be measured, is calculated by emitting a modulated optical pulse toward the distance-measurement-target object and receiving a reflection of the modulated optical pulse coming from the distance-measurement-target object. Note that the optical pulse may be periodically and repeatedly transmitted.

In relation to this technique, Patent Literature 1 discloses a distance-measurement apparatus. The distance-measurement apparatus according to Patent Literature 1 includes a generation unit, a transmission unit, a reception unit, a detection unit, and a distance calculation unit. The generation unit generates a plurality of transmission pulses of which a strength of an optical signal changes in a pulse-like manner. At this time, the generation unit generates a plurality of transmission pulses having frequency offsets different from each other. The transmission unit repeatedly transmits the transmission pulses generated by the generation unit. The reception unit receives reflected pulses of the respective transmission pulses reflected on a distance-measurement-target object. The detection unit detects the frequency offsets of the reflected pulses received by the reception unit. The distance calculation unit calculates a distance to the distance-measurement-target object based on receiving timings of the reflected pulses received by the reception unit and transmitting timings of the transmission pulses corresponding to the frequency offsets detected from the reflected pulses. With the above configuration, the distance-measurement apparatus according to Patent Literature 1 can properly perform distance measurement regardless of the distance to the distance-measurement-target object or a transmission period of the transmission pulses.

### CITATION LIST

### Patent Literature

Patent Literature 1: International Patent Publication No. WO2020/079776

### SUMMARY OF INVENTION

### Technical Problem

When attempting to achieve miniaturization of the distance-measurement apparatus, there is a possibility of light spillage from a transmitting side to a receiving side in the apparatus. In this case, there is a possibility that incorrect distance measurement is performed due to the light spillage reaching the receiving side. Therefore, there is a possibility that accurate distance measurement cannot be performed.

An object of the present disclosure is to solve such a problem, and is to provide a distance-measurement apparatus and a distance-measurement method capable of preventing incorrect distance measurement.

### Solution to Problem

A distance-measurement apparatus according to the present disclosure includes: generation means for generating a plurality of transmission pulses of which a strength of an optical signal changes in a pulse-like manner, the plurality of transmission pulses having frequency offsets different from each other with respect to a reference frequency: transmission means for repeatedly transmitting the generated transmission pulses: reception means for receiving reflected pulses of the transmission pulses reflected on a distance-measurement-target object; detection means for detecting frequency offsets of the received reflected pulses; distance calculation means for calculating a distance to the distance-measurement-target object based on receiving timings of the received reflected pulses and transmitting timings of the transmission pulses corresponding to the frequency offsets detected from the reflected pulses; and invalidation processing means for performing processing of invalidating distance calculation processing for a certain period based on the transmitting timings of the transmission pulses.

Further, a distance-measurement method according to the present disclosure includes: generating a plurality of transmission pulses of which a strength of an optical signal changes in a pulse-like manner, the plurality of transmission pulses having frequency offsets different from each other with respect to a reference frequency: repeatedly transmitting the generated transmission pulses: receiving reflected pulses of the transmission pulses reflected on a distance-measurement-target object: detecting frequency offsets of the received reflected pulses: calculating a distance to the distance-measurement-target object based on receiving timings of the received reflected pulses and transmitting timings of the transmission pulses corresponding to the frequency offsets detected from the reflected pulses; and performing processing of invalidating distance calculation processing for a certain period based on the transmitting timings of the transmission pulses.

### Advantageous Effects of Invention

According to the present disclosure, it is possible to provide a distance-measurement apparatus and a distance-measurement method capable of preventing incorrect distance measurement.

### BRIEF DESCRIPTION OF DRAWINGS

FIG. 1 is a diagram showing an outline of a distance-measurement apparatus according to an example embodiment of the present disclosure.

FIG. 2 is a diagram showing an outline of a distance-measurement method executed by the distance-measurement apparatus according to the example embodiment of the present disclosure.

FIG. 3 is a diagram for explaining an outline of a method for calculating a distance to a distance-measurement-target object by using pulses according to a first comparative example.

FIG. 4 is a diagram for explaining a problem according to the first comparative example.

FIG. 5 is a diagram for explaining a problem according to the first comparative example.

FIG. 6 is a diagram showing a configuration of a distance-measurement apparatus according to a second comparative example.

FIG. 7 is a diagram for explaining operations performed by an optical modulator according to a second comparative example.

FIG. 8 is a timing chart showing a relation between transmission pulses and reflected pulses according to the second comparative example.

FIG. 9 is a timing chart showing a relation between transmission pulses and reflected pulses according to the second comparative example.

FIG. 10 is a diagram showing a configuration in a case of miniaturizing the distance-measurement apparatus.

FIG. 11 is a diagram showing a configuration in a case of miniaturizing the distance-measurement apparatus.

FIG. 12 is a timing chart in a case of miniaturizing the distance-measurement apparatus in the second comparative example.

FIG. 13 is a diagram showing a configuration of a distance-measurement apparatus according to a first example embodiment.

FIG. 14 is a timing chart showing a relation among a transmission pulse, a receiving-side signal, and an output signal of a bandpass filter according to the first example embodiment.

FIG. 15 is a flowchart showing a distance-measurement method executed by the distance-measurement apparatus according to the first example embodiment.

FIG. 16 is a diagram for explaining a first example of a method for changing a transmission interval according to a second example embodiment.

FIG. 17 is a diagram for explaining a second example of the method for changing the transmission interval according to the second example embodiment.

FIG. 18 is a diagram for explaining a third example of the method for changing the transmission interval according to the second example embodiment.

FIG. 19 is a diagram for explaining effects of characteristics according to the second example embodiment.

FIG. 20 is a diagram for explaining the effects of the characteristics according to the second example embodiment.

FIG. 21 is a flowchart showing a distance-measurement method executed by a distance-measurement apparatus according to the second example embodiment.

FIG. 22 is a diagram showing a configuration of a distance-measurement apparatus according to a third example embodiment.

FIG. 23 is a flowchart showing a distance-measurement method executed by the distance-measurement apparatus according to the third example embodiment.

FIG. 24 is a diagram showing a configuration of a distance-measurement apparatus according to a fourth example embodiment.

FIG. 25 is a diagram showing distance measurement information stored in a database according to the fourth example embodiment.

FIG. 26 is a flowchart showing a distance-measurement method executed by the distance-measurement apparatus according to the fourth example embodiment.

### EXAMPLE EMBODIMENT

### Outline of Example Embodiments According to Present Disclosure

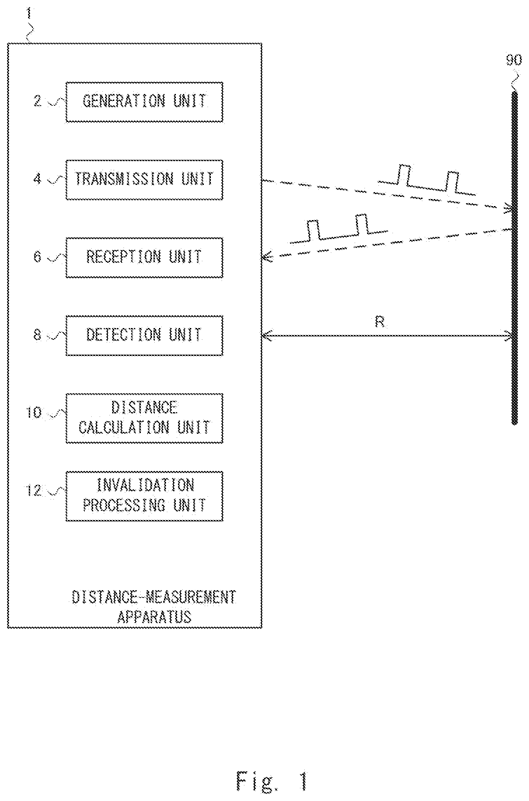

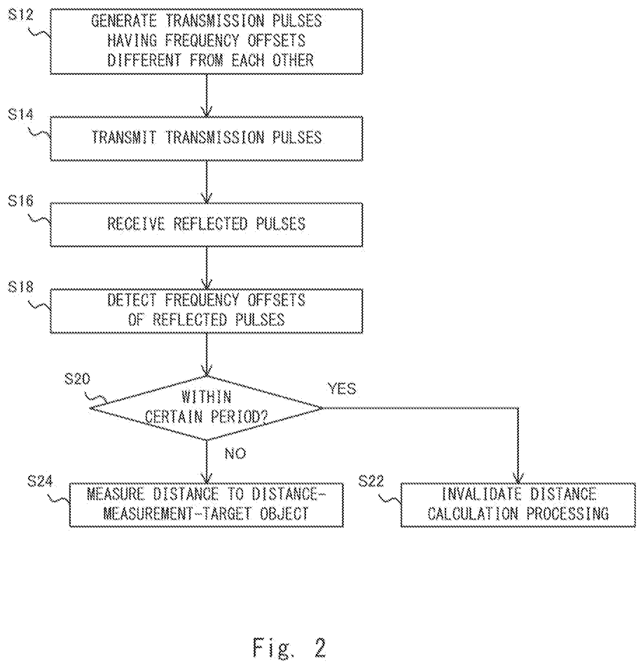

Prior to describing example embodiments of the present disclosure, an outline of example embodiments according to the present disclosure will be described. FIG. 1 is a diagram showing an outline of a distance-measurement apparatus 1 according to an example embodiment of the present disclosure. FIG. 2 is a diagram showing an outline of a distance-measurement method executed by the distance-measurement apparatus 1 according to the example embodiment of the present disclosure.

The distance-measurement apparatus 1 includes a generation unit 2, a transmission unit 4, a reception unit 6, a detection unit 8, a distance calculation unit 10, and an invalidation processing unit 12. The generation unit 2 has a function as generation means. The transmission unit 4 has a function as transmission means. The reception unit 6 has a function as reception means. The detection unit 8 has a function as detection means. The distance calculation unit 10 has a function as distance calculation means. The invalidation processing unit 12 has a function as invalidation processing means. Note that the transmission unit 4 and the reception unit 6 may be physically integrated. As a result, the distance-measurement apparatus 1 can be miniaturized.

The generation unit 2 generates a plurality of transmission pulses of which a strength of an optical signal changes in a pulse-like manner. At this time, the generation unit 2 generates a plurality of transmission pulses having frequency offsets different from each other (step S12). Note that the frequency offset is a deviation (offset) with respect to a certain reference frequency.

The transmission unit 4 repeatedly transmits the transmission pulses generated by the generation unit 2 (step S14). The reception unit 6 receives reflected pulses of the transmission pulses reflected on a distance-measurement-target object 90 (step S16). The detection unit 8 detects the frequency offsets of the reflected pulses received by the reception unit 6 (step S18).

Furthermore, the distance calculation unit 10 calculates a distance R to the distance-measurement-target object 90 based on receiving timings of the reflected pulses received by the reception unit 6 and transmitting timings of the transmission pulses corresponding to the frequency offsets detected from the reflected pulses. On the other hand, the invalidation processing unit 12 performs processing of invalidating distance calculation processing performed by the distance calculation unit 10 for a certain period based on the transmitting timings of the transmission pulses. For example, the invalidation processing unit 12 may perform processing of invalidating the distance calculation processing by invalidating a receiving-side signal input to a receiving side for a certain period from the transmitting timing.

Therefore, in a case where the current time point is within the certain period based on the transmitting timing (YES in step S20), the invalidation processing unit 12 performs processing for invalidating the distance calculation processing (step S22). On the other hand, in a case where the current time point is not within the certain period based on the transmitting timing (NO in S20), the distance calculation unit 10 calculates the distance R to the distance-measurement-target object 90 (step S24).

### First Comparative Example

Here, a first comparative example using a general ToF method will be described.

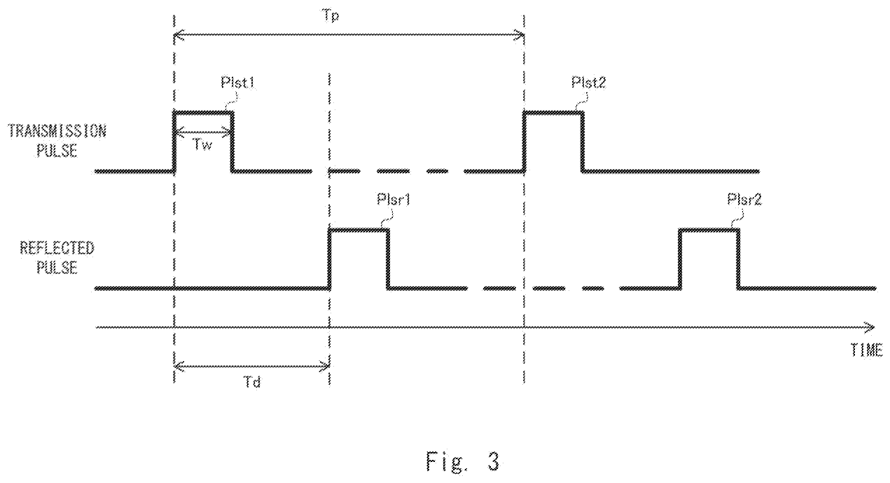

FIG. 3 is a diagram for explaining an outline of a method for calculating a distance to the distance-measurement-target object 90 by using pulses according to the first comparative example. FIG. 3 shows the principle of operations according to a ToF method. The transmission unit 4 transmits transmission pulses Plst1 and Plst2 at a transmission period (a transmission interval or pulse period) Tp. Note that a pulse width, i.e., a width of each transmission pulse is represented by Tw. Then, when the transmission pulse Plst1 is reflected on the distance-measurement-target object 90, the reception unit 6 receives a reflected pulse Plsr1 which is reflected light of the transmission pulse Plst1. Further, when the transmission pulse Plst2 is reflected on the distance-measurement-target object 90, the reception unit 6 receives a reflected pulse Plsr2 which is reflected light of the transmission pulse Plst2.

Further, a time difference between a time at which the transmission pulse Plst1 is transmitted and a time at which the reflected pulse Plsr1 is received, that is, a flight time of the light (pulse) is represented by Td. Further, the speed of light is represented by c. In this case, the distance R to the distance-measurement-target object 90 is expressed by the following Expression 1.

$$R = c \times Td / 2 \qquad ( Expression 1 )$$

In this way, the distance R is calculated by the distance calculation unit 10.

In the first comparative example shown in FIG. 3, the two transmission pulses Plst1 and Plst2 are transmitted at the pulse period Tp, and the reflected pulses Plsr1 and Plsr2, which are the reflected light of the transmission pulses Plst1 and Plst2, respectively, are received. Note that when the distance to the distance-measurement-target object 90 is long, in some cases, the time difference Td becomes longer than the pulse period Tp. Further, even when the pulse period Tp is short, in some cases, the time difference Td becomes longer than the pulse period Tp. That is, in some cases, Td>Tp depending on the distance to the distance-measurement-target object 90 or the pulse period. In such a case, the next transmission pulse Plst2 is transmitted before the reflected pulse Plsr1 is received. In this case, if it is not possible to determine whether the received reflected pulse Plsr1 is the reflected light of the transmission pulse Plst1 or the reflected light of the transmission pulse Plst2, there is a possibility that the distance cannot be properly measured. That is, if the distance is measured from the time difference between a transmitting time of the transmission pulse Plst2 and a receiving time of the reflected pulse Plsr1, a distance shorter than the actual distance to the distance-measurement-target object 90 is calculated. Such a problem will be described in detail below.

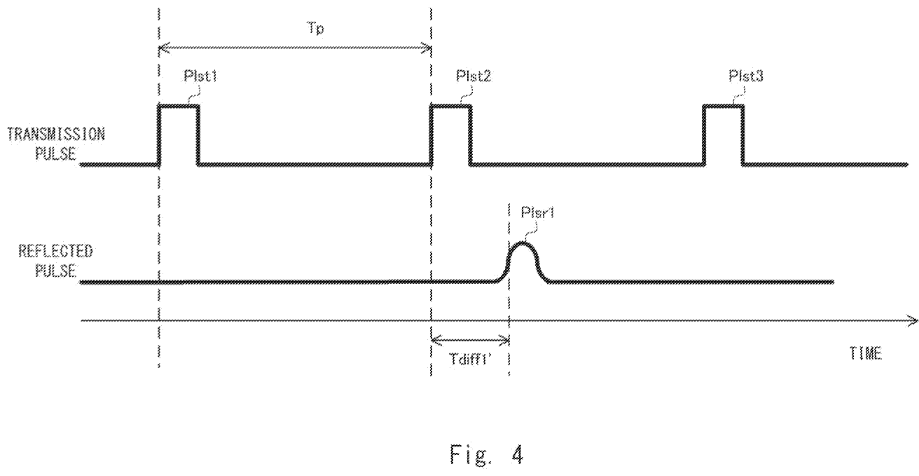

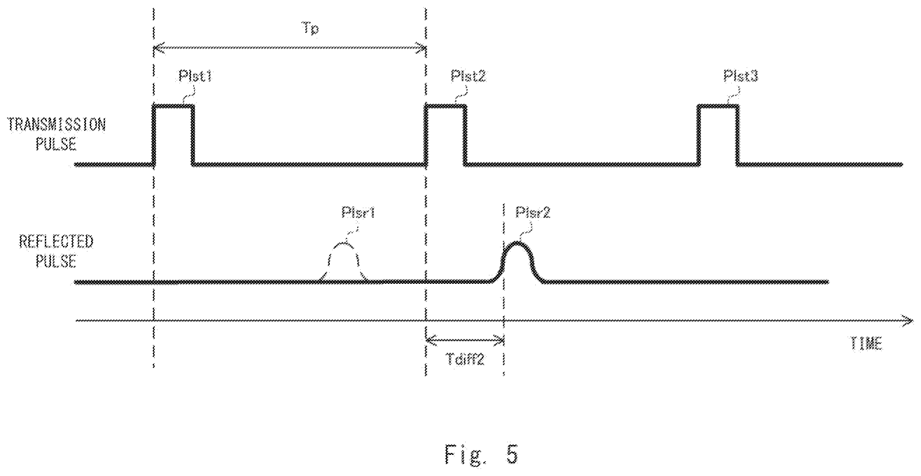

FIGS. 4 and 5 are diagrams for explaining a problem according to the first comparative example. FIGS. 4 and 5 are timing charts showing a relation between transmission pulses and reflected pulses according to the first comparative example. In the examples shown in FIGS. 4 and 5, it is assumed that transmission pulses Plst1, Plst2, and Plst3 are transmitted at the pulse period Tp. Further, it is assumed that the transmission pulses Plst1, Plst2, and Plst3 have the same frequency. Further, in the example shown in FIG. 4, it is assumed that the flight time until a transmission pulse is reflected on the distance-measurement-target object 90 and returned is longer than the pulse period Tp.

First, the transmission pulse Plst1 is transmitted. Thereafter, after the transmission pulse Plst2 is transmitted, the reflected pulse Plsr1, which is the transmission pulse Plst1 that has been reflected on the distance-measurement-target object 90, is received. At this time, in the first comparative example shown in FIG. 4, there is a possibility that a distance is measured by using a time difference Tdiff1′ between the transmitting timing of the transmission pulse Plst2 and the receiving timing of the reflected pulse Plsr1. When a distance is measured by using the time difference Tdiff1′ as described above, the distance is incorrectly calculated.

On the other hand, in the example shown in FIG. 5, it is assumed that the flight time until a transmission pulse is reflected on the distance-measurement-target object 90 and returned is shorter than the pulse period Tp. Further, it is assumed that the transmission pulse Plst1 is not reflected, so that no reflected pulse Plsr1 of the transmission pulse Plst1 is received. Further, it is assumed that the transmission pulse Plst2 is reflected on the distance-measurement-target object and its reflected pulse Plsr2 is received. In this case, the distance is measured by using a time difference Tdiff2 between the transmitting timing of the transmission pulse Plst2 and the receiving timing of the reflected pulse Plsr2. Although this distance-measurement processing is correct, it cannot be distinguished from the processing shown in FIG. 4.

In order to cope with the problem shown in FIGS. 4 and 5, it is conceivable to increase the pulse period when it is presumed that the distance to the distance-measurement-target object is long. In this way, it is possible to prevent the incorrect measurement of a distance like the one shown in FIG. 4. However, if the pulse period is increased, the length of the time from a time at which a distance is measured to a time at which the next distance is measured is increased, so that the speed of the distance measurement may decrease. Therefore, since distances cannot be measured at a desired speed, the distance measurement cannot be performed properly. In contrast to this, a distance-measurement apparatus 50 according to a second comparative example can measure distances without increasing the pulse period as described below.

### Second Comparative Example

Next, the second comparative example will be described.

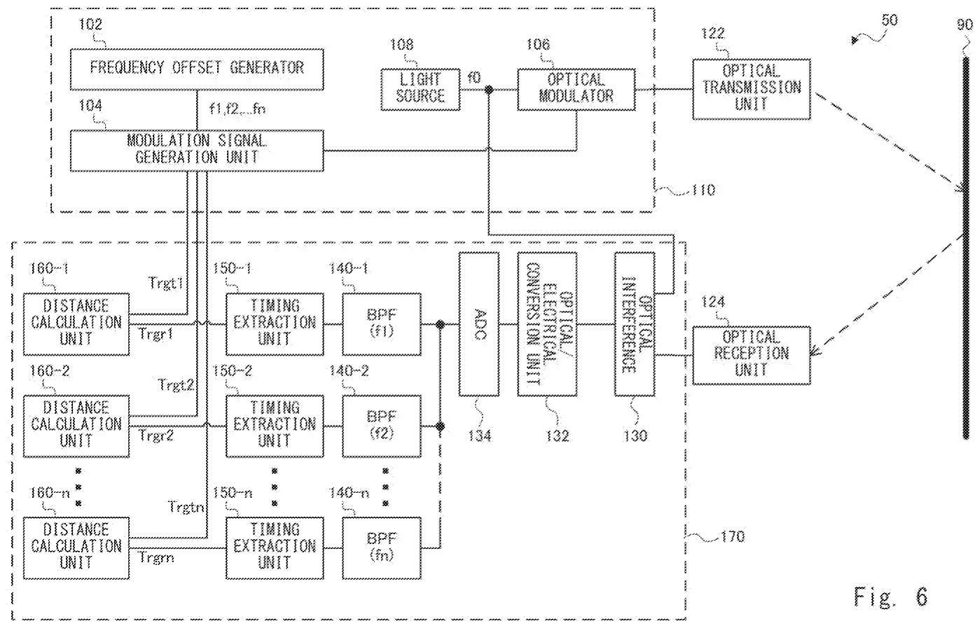

FIG. 6 is a diagram showing a configuration of the distance-measurement apparatus 50 according to the second comparative example. The second comparative example corresponds to the matter disclosed in Patent Document 1. The distance-measurement apparatus 50 according to the second comparative example includes, as a transmitting-side module, a frequency offset generator 102, a modulation signal generation unit 104, an optical modulator 106, a light source 108, and an optical transmission unit 122. The frequency offset generator 102, the modulation signal generation unit 104, the optical modulator 106, and the light source 108 constitute a transmitting-side unit 110. The transmitting-side unit 110 functions as a pulse generation unit that generates a plurality of transmission pulses having frequency offsets different from each other.

Furthermore, the distance-measurement apparatus 50 according to the second comparative example includes, as a receiving-side module, an optical reception unit 124, an optical interference unit 130, an optical/electrical conversion unit 132, and an AD converter 134. Furthermore, the distance-measurement apparatus 50 according to the second comparative example includes, as a receiving-side module, bandpass filters 140-1 to 140-n, timing extraction units 150-1 to 150-n, and distance calculation units 160-1 to 160-n. Note that n is an integer equal to or greater than two. Further, in the following description, when the plurality of bandpass filters 140-1 to 140-n or the like are not distinguished from each other, they may be collectively referred to as the bandpass filter(s) 140 or the like. Note that n represents the number of frequency offsets. In addition, the optical interference unit 130, the optical/electrical conversion unit 132, the AD converter 134, the bandpass filter 140, the timing extraction unit 150, and the distance calculation unit 160 constitute a receiving-side unit 170.

In the second comparative example, the frequency offsets are represented by f1, f2, . . . , and fn. Therefore, the bandpass filters 140-1 to 140-n correspond to the frequency offsets f1 to fn, respectively. Similarly, the timing extraction units 150-1 to 150-n correspond to the frequency offsets f1 to fn, respectively. The distance calculation units 160-1 to 160-n correspond to the frequency offsets f1 to fn, respectively. Note that each of the above-described components can be implemented by some kind of a device or a circuit such as an arithmetic circuit or the like. The arithmetic circuit is, for example, a field-programmable gate array (FPGA) or the like.

The frequency offset generator 102 outputs frequency offset information, which is information indicating a plurality of frequency offsets that are offsets from a reference frequency f0, to the modulation signal generation unit 104. Note that the frequency offset information indicates the frequency offsets f1, f2, . . . , and fn. Note that the frequency offset generator 102 may output the frequency offset information indicating the frequency offsets f1, f2, . . . , and fn to the modulation signal generation unit 104 at each pulse period Tp. That is, the frequency offset generator 102 may output frequency offset information indicating the frequency offset f1 and then, after a time Tp has elapsed, output frequency offset information indicating the frequency offset f2.

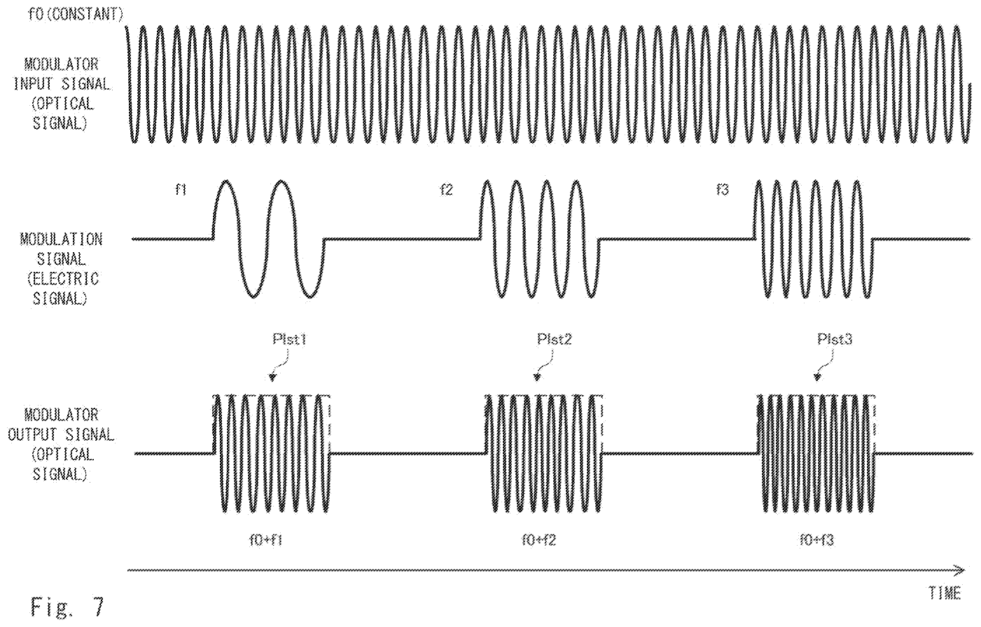

The modulation signal generation unit 104 may generate a modulation signal for generating transmission pulses according to the frequency offset information received from the frequency offset generator 102. Note that as shown in FIG. 7 to be described later, the modulation signal is an electric signal having a waveform corresponding to the frequency offsets f1, f2, . . . , and fn. The modulation signal generation unit 104 outputs the generated modulation signal to the optical modulator 106.

The frequency offset generator 102 may output the frequency offset information indicating all the frequency offsets f1, f2, . . . , fn to the modulation signal generation unit 104. In this case, the modulation signal generation unit 104 may generate modulation signals corresponding to the frequency offsets f1, f2, . . . , and fn, respectively, at each pulse period Tp. That is, the modulation signal generation unit 104 may generate a modulation signal indicating the frequency offset f1, and then, after the time Tp has elapsed, generate a modulation signal indicating the frequency offset f2.

Furthermore, the modulation signal generation unit 104 outputs a measurement start trigger Trgt to the distance calculation unit 160 at a timing at which each of transmission pulses corresponding to the frequency offsets f1, f2, and fn are transmitted. Note that the measurement start trigger Trgt indicates the transmitting timing of each of the transmission pulses having the respective frequency offsets. Specifically, the modulation signal generation unit 104 outputs the measurement start trigger Trgt1 to the distance calculation unit 160-1 at a timing at which a modulation signal corresponding to the frequency offset f1 is output. Further, the modulation signal generation unit 104 outputs a measurement start trigger Trgt2 to the distance calculation unit 160-2 at a timing at which a modulation signal corresponding to the frequency offset f2 is output. Similarly and subsequently, the modulation signal generation unit 104 outputs a measurement start trigger Trgtn to the distance calculation unit 160-n at a timing at which a modulation signal corresponding to the frequency offset fn is output.

The light source 108 generates an optical signal having the reference frequency f0 as shown in FIG. 7 to be described later. The optical signal is input to the optical modulator 106 and the optical interference unit 130. The optical modulator 106 generates a plurality of transmission pulses having the frequency offsets f1, f2, . . . , and fn different from each other by using the modulation signal input from the modulation signal generation unit 104 and the optical signal (modulator input signal) input from the light source 108. The optical modulator 106 outputs an optical signal including the generated transmission pulse to the optical transmission unit 122.

For example, the optical modulator 106 is an acousto-optic (AO) modulator. The optical modulator 106 modulates the optical signal (modulator input signal) by using the modulation signal. In this way, the optical modulator 106 generates a plurality of transmission pulses having frequency offsets different from each other.

FIG. 7 is a diagram for explaining operations performed by the optical modulator 106 according to the second comparative example. FIG. 7 shows an example in which n is three (n=3), i.e., the number of frequency offsets is three. As shown in FIG. 7, the optical signal (modulator input signal) input to the optical modulator 106 is an optical signal having a constant frequency f0. Further, the modulation signal has a pulse-like waveform having a frequency f1, a pulse-like waveform having a frequency f2, and a pulse-like waveform having a frequency f3. Note that the amplitude of the modulation signal is 0 V except for the pulse-like waveforms. Each of the waveforms is a sine wave having a width Tw.

Note that the optical modulator 106 modulates the optical signal according to the pulse-like waveform of the modulation signal, and outputs the modulated optical signal (modulator output signal). This modulator output signal corresponds to the transmission pulse. When the optical modulator 106 receives a modulation signal having a pulse-like waveform having the frequency f1, the optical modulator 106 modulates the optical signal having the frequency f0 so as to f1-shift the optical signal, and outputs a pulse having a frequency (f0+f1). This pulse corresponds to the transmission pulse Plst1. Further, when the optical modulator 106 receives a modulation signal having a pulse-like waveform having the frequency f2, the optical modulator 106 modulates the optical signal having the frequency f0 so as to f2-shift the optical signal, and outputs a pulse having a frequency (f0+f2). This pulse corresponds to the transmission pulse Plst2. Further, when the optical modulator 106 receives a modulation signal having a pulse-like waveform having the frequency f3, the optical modulator 106 modulates the optical signal having the frequency f0 so as to f3-shift the optical signal, and outputs a pulse having a frequency (f0+f3). This pulse corresponds to the transmission pulse Plst3. Therefore, the transmission pulse indicates a signal of which the optical strength changes in a pulse-like manner. In this way, the transmission pulses Plst1, Plst2, and Plst3 have the frequency offsets f1, f2, and f3, respectively, different from each other. Note that broken lines in the modulator output signal indicates the optical strength (envelope).

Note that the modulation signal generation unit 104 may output the measurement start trigger Trgt1 to the distance calculation unit 160-1 at a timing at which the modulation signal having the pulse-like waveform having the frequency f1 is output. The modulation signal generation unit 104 may output the measurement start trigger Trgt2 to the distance calculation unit 160-2 at a timing at which the modulation signal having the pulse-like waveform having the frequency f2 is output. The modulation signal generation unit 104 may output a measurement start trigger Trgt3 to the distance calculation unit 160-3 at a timing at which the modulation signal having the pulse-like waveform having the frequency f3 is output.

The optical transmission unit 122 transmits (emits) an optical signal including a plurality of transmission pulses to the distance-measurement-target object 90. The transmission pulses are reflected on the distance-measurement-target object 90 and travel toward the distance-measurement apparatus 50. The optical reception unit 124 receives an optical signal including a plurality of reflected pulses reflected on the distance-measurement-target object 90. Not that the frequencies of the plurality of received reflected pulses are frequencies f0+f1, f0+f2, . . . , f0+fn. Note that the plurality of transmission pulses do not necessarily have to be applied to the same distance-measurement-target object 90. Therefore, the flight time for a round trip of the transmission pulse Plst1 and that of the transmission pulse Plst2 may be different from each other.

The optical interference unit 130 detects a frequency offset of the reflected pulse (received light) by using an optical signal having the frequency f0 received from the light source 108 as reference light. Specifically, the optical interference unit 130 makes the reference light received from the light source 108 interfere with the received light and detects their beat frequency. In this way, the optical interference unit 130 detects the frequency offset of the reflected pulse. For example, the optical interference unit 130 may be a mixer using an optical coupler. Alternatively, the optical interference unit 130 may be, for example, a 90-degree hybrid circuit that makes the received light interfere with reference light, i.e., with reference light having two phases of 0 degrees and 90 degrees. The optical interference unit 130 outputs optical signals having the frequencies f1, f2, . . . , and fn corresponding to the frequency offsets to the optical/electrical conversion unit 132.

The optical/electrical conversion unit 132 converts the optical signal received from the optical interference unit 130 into an electric signal. The optical/electrical conversion unit 132 may be, for example, an optical/electrical converter using a photodetector or a balanced optical receiver using two photodetectors. The AD converter 134 converts the electric signal, which is an analog signal converted by the optical/electrical conversion unit 132, into a digital signal. The electric signal indicating the frequencies f1, f2, . . . , fn which has been obtained as the AD converter 134 has converted the analog signal into the digital signal, is output to the bandpass filters 140-1 to 140-n.

The bandpass filter (BPF) 140 uses a frequency corresponding to the frequency offset as its center frequency. The center frequencies of the bandpass filters 140-1 to 140-n are the frequencies f1 to fn, respectively. Therefore, the bandpass filters 140-1 to 140-n let electric signals indicating the frequencies f1 to fn, respectively, pass therethrough. Therefore, the bandpass filter 140 has a function as separation means for separating the optical signal for each of the frequency offsets of the reflected pulses detected by the optical interference unit 130 (the detection unit 8).

The timing extraction unit 150 functions as timing extraction means for extracting the receiving timing of the received reflected pulse. The timing extraction units 150-1 to 150-n extract the receiving timings of the reflected pulses having the frequency offsets f1 to fn, respectively. Then, the timing extraction units 150-1 to 150-n output measurement stop triggers Trgr1 to Trgrn to the distance calculation units 160-1 to 160-n at the receiving timings of the reflected pulses having the frequency offsets f1 to fn, respectively. That is, the measurement stop triggers Trgr indicate the receiving timings of the reflected pulses having the frequency offsets f1 to fn, respectively.

The distance calculation unit 160 calculates a distance R to the distance-measurement-target object 90, by using Expression 1, from a time difference between the output timing of the measurement start trigger Trgt (first trigger signal) and an output timing of the measurement stop trigger Trgr (second trigger signal). Note that the distance calculation unit 160-1 calculates a distance R related to the transmission pulse having the frequency offset f1 from a time difference between the output timing of the measurement start trigger Trgt1 and the output timing of the measurement stop trigger Trgr1. The distance calculation unit 160-2 calculates a distance R related to the transmission pulse having the frequency offset f2 from a time difference between the output timing of the measurement start trigger Trgt2 and the output timing of the measurement stop trigger Trgr2. Similarly and subsequently, the distance calculation unit 160-n calculates a distance R related to the transmission pulse having the frequency offset fn from a time difference between the output timing of the measurement start trigger Trgtn and the output timing of the measurement stop trigger Trgrn.

Note that the plurality of frequency offsets may be predetermined frequencies at equal intervals, such as f1=+100 MHz, f2=+200 MHZ, and f3=+300 MHz. However, in some cases, a frequency offset of +200 MHz cannot be used in order to avoid the deterioration of the characteristic of a certain frequency due to the characteristics of the distance-measurement apparatus or the like. In such a case, the frequency offsets may be predetermined frequencies that are not equally spaced, such as f1=+100 MHz, f2=+350 MHz, and f3=+270 MHz.

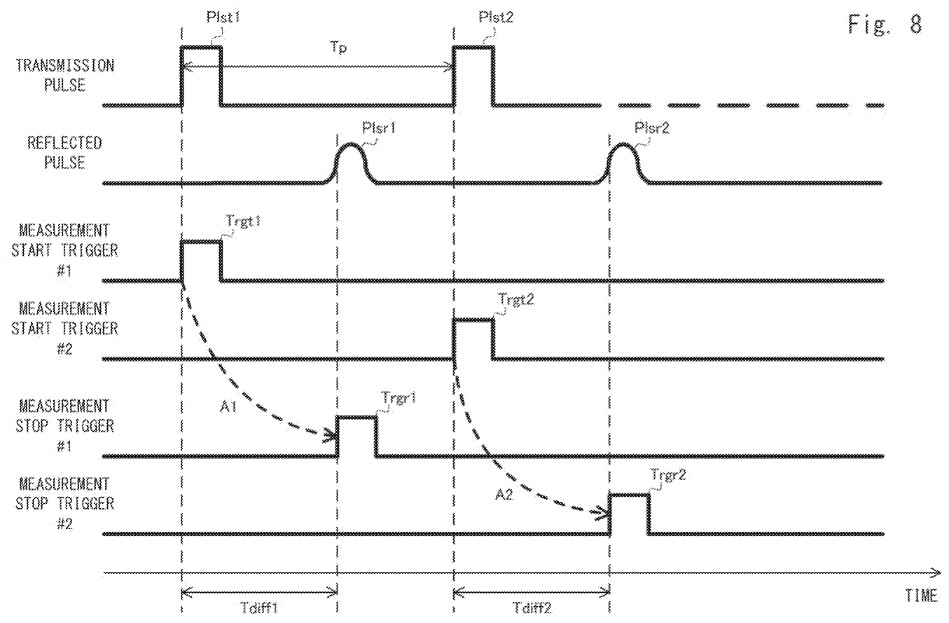

FIG. 8 is a timing chart showing a relation between transmission pulses and reflected pulses according to the second comparative example. In the example shown in FIG. 8, it is assumed that the transmission pulses Plst1 and Plst2 are transmitted at the pulse period Tp. Furthermore, in the example shown in FIG. 8, it is assumed that the flight time until a transmission pulse is reflected on the distance-measurement-target object 90 and returned is shorter than the pulse period Tp.

First, the transmission pulse Plst1 having the frequency offset f1 is transmitted. At this transmitting timing, the measurement start trigger Trgt1 is output to the distance calculation unit 160-1. Thereafter, the reflected pulse Plsr1 having the frequency offset f1 is received before the transmission pulse Plst2 is transmitted. At this receiving timing, the frequency offset f1 is detected, the reflected pulse Plsr1 is separated by the bandpass filter 140-1, and the measurement stop trigger Trgr1 is output from the timing extraction unit 150-1 to the distance calculation unit 160-1. Note that the transmitted optical signal is attenuated due to the reflection on the distance-measurement-target object 90 and through a flight process of the optical signal. As a result, the waveform of the envelope of the reflected pulse Plsr1 is blunted as compared to the waveform of the envelope of the transmission pulse Plst1. Therefore, the timing extraction unit 150-1 outputs the measurement stop trigger Trgr1 at a timing at which the optical strength of the reflected pulse Plsr1 exceeds a predetermined threshold. The same applies to the other reflected pulses such as the reflected pulse Plsr2.

At this point, the transmission pulse Plst1 having the frequency offset f1 and the reflected pulse Plsr1 having the frequency offset f1 are associated with each other by the distance calculation unit 160-1. Therefore, as shown by a broken-line arrow A1, the measurement start trigger Trgt1 indicating the transmitting timing of the transmission pulse Plst1 and the measurement stop trigger Trgr1 indicating the receiving timing of the reflected pulse Plsr1 are associated with each other by the distance calculation unit 160-1. In this way, the distance calculation unit 160-1 calculates a distance to the distance-measurement-target object 90 from a time difference Tdiff1 between the measurement start trigger Trgt1 and the measurement stop trigger Trgr1. Therefore, the distance calculation unit 160-1 can properly calculate the distance to the distance-measurement-target object 90 on which the transmission pulse Plst1 has been reflected.

Similarly, the transmission pulse Plst2 having the frequency offset f2 is transmitted. At this transmitting timing, the measurement start trigger Trgt2 is output to the distance calculation unit 160-2. Thereafter, the reflected pulse Plsr2 having the frequency offset f2 is received before the transmission pulse Plst3 (not shown) is transmitted. At this receiving timing, the frequency offset f2 is detected, the reflected pulse Plsr2 is separated by the bandpass filter 140-2, and the measurement stop trigger Trgr2 is output from the timing extraction unit 150-2 to the distance calculation unit 160-2.

At this point, the transmission pulse Plst2 having the frequency offset f2 and the reflected pulse Plsr2 having the frequency offset f2 are associated with each other by the distance calculation unit 160-2. Therefore, as shown by a broken-line arrow A2, the measurement start trigger Trgt2 indicating the transmitting timing of the transmission pulse Plst2 and the measurement stop trigger Trgr2 indicating the receiving timing of the reflected pulse Plsr2 are associated with each other by the distance calculation unit 160-2. In this way, the distance calculation unit 160-2 calculates a distance to the distance-measurement-target object 90 from a time difference Tdiff2 between the measurement start trigger Trgt2 and the measurement stop trigger Trgr2. Therefore, the distance calculation unit 160-2 can properly calculate the distance to the distance-measurement-target object 90 on which the transmission pulse Plst2 has been reflected.

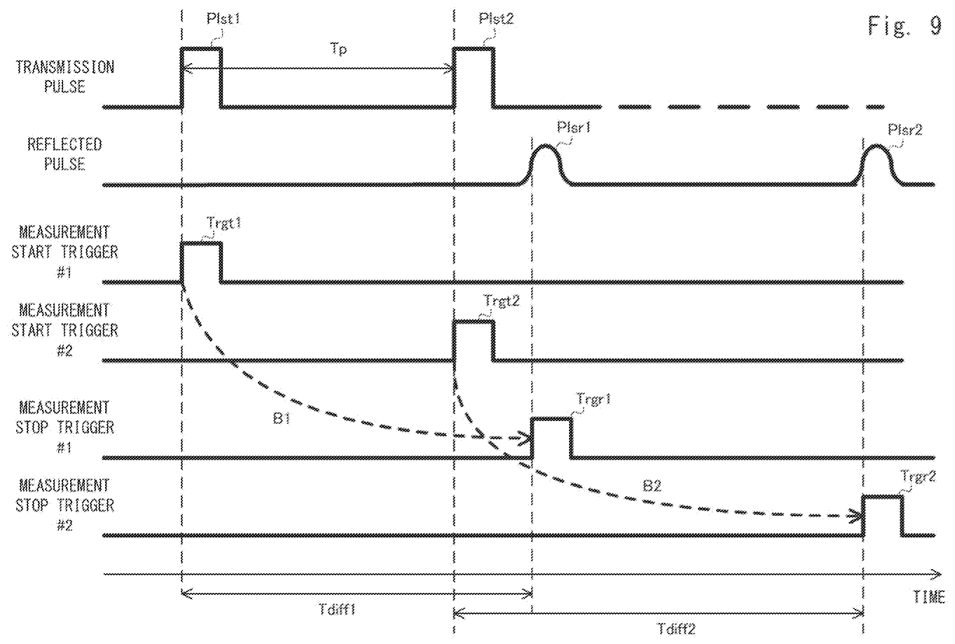

FIG. 9 is a timing chart showing a relation between transmission pulses and reflected pulses according to the second comparative example. In the example shown in FIG. 9, it is assumed that the transmission pulses Plst1 and Plst2 are transmitted at the pulse period Tp. Further, in the example shown in FIG. 9, it is assumed that the flight time until a transmission pulse is reflected on the distance-measurement-target object 90 and returned is longer than the pulse period Tp.

First, the transmission pulse Plst1 having the frequency offset f1 is transmitted. At this transmitting timing, the measurement start trigger Trgt1 is output to the distance calculation unit 160-1. Thereafter, the reflected pulse Plsr1 having the frequency offset f1 is received after the transmission pulse Plst2 is transmitted. At this receiving timing, the frequency offset f1 is detected, the reflected pulse Plsr1 is separated by the bandpass filter 140-1, and the measurement stop trigger Trgr1 is output from the timing extraction unit 150-1 to the distance calculation unit 160-1.

At this point, the transmission pulse Plst1 having the frequency offset f1 and the reflected pulse Plsr1 having the frequency offset f1 are associated with each other by the distance calculation unit 160-1. Therefore, as shown by a broken-line arrow B1, the measurement start trigger Trgt1 indicating the transmitting timing of the transmission pulse Plst1 and the measurement stop trigger Trgr1 indicating the receiving timing of the reflected pulse Plsr1 are associated with each other by the distance calculation unit 160-1. In this way, the distance calculation unit 160-1 calculates a distance to the distance-measurement-target object 90 from a time difference Tdiff1 between the measurement start trigger Trgt1 and the measurement stop trigger Trgr1. Therefore, even when the flight time of the optical signal is longer than the pulse period, the distance calculation unit 160-1 can properly calculate the distance to the distance-measurement-target object 90 on which the transmission pulse Plst1 has been reflected.

Similarly, the transmission pulse Plst2 having the frequency offset f2 is transmitted. At this transmitting timing, the measurement start trigger Trgt2 is output to the distance calculation unit 160-2. Thereafter, the reflected pulse Plsr2 having the frequency offset f2 is received after the transmission pulse Plst3 (not shown) is transmitted. At this receiving timing, the frequency offset f2 is detected, the reflected pulse Plsr2 is separated by the bandpass filter 140-2, and the measurement stop trigger Trgr2 is output from the timing extraction unit 150-2 to the distance calculation unit 160-2.

At this point, the transmission pulse Plst2 having the frequency offset f2 and the reflected pulse Plsr2 having the frequency offset f2 are associated with each other by the distance calculation unit 160-2. Therefore, as shown by a broken-line arrow B2, the measurement start trigger Trgt2 indicating the transmitting timing of the transmission pulse Plst2 and the measurement stop trigger Trgr2 indicating the receiving timing of the reflected pulse Plsr2 are associated with each other by the distance calculation unit 160-2. In this way, the distance calculation unit 160-2 calculates a distance to the distance-measurement-target object 90 from a time difference Tdiff2 between the measurement start trigger Trgt2 and the measurement stop trigger Trgr2. Therefore, even when the flight time of the optical signal is longer than the pulse period, the distance calculation unit 160-2 can properly calculate the distance to the distance-measurement-target object 90 on which the transmission pulse Plst2 has been reflected.

As described above, the distance calculation unit 160 according to the second comparative example calculates the distance R by associating a measurement start trigger signal related to a transmission pulse having a certain frequency offset with a measurement stop trigger signal related to a reflected pulse having this frequency offset. In other words, a transmission pulse and a reflected pulse having frequency offsets corresponding to each other are associated with each other by the distance calculation unit 160. In this way, the distance-measurement apparatus 50 according to the second comparative example can properly associate a transmission pulse with a reflected pulse, which is reflected light of the transmission pulse reflected on the distance-measurement-target object 90. Therefore, it is possible to properly perform distance measurement regardless of the distance to the distance-measurement-target object or the transmission period of transmission pulses.

Further, the distance-measurement apparatus 50 according to the second comparative example is configured to separate a received optical signal for each of the frequency offsets of the reflected pulses by using the bandpass filter 140 (separation means). Since the separation of an optical signal using the bandpass filter 140 can be performed by hardware, it can be performed at a higher speed as compared to the processing performed by software. Further, by the separation using the bandpass filter 140, it is possible to perform parallel processing on a frequency offset basis. That is, the distance calculation unit 160 can calculate the distance R for each separated signal. Therefore, the distance-measurement apparatus 50 according to the second comparative example can perform the distance-measurement processing at a high speed. Further, it is possible to easily extract the receiving timing of each reflected pulse by separating a received signal for each of the frequency offsets of the reflected pulses.

Note that a case of miniaturizing the distance-measurement apparatus will be described.

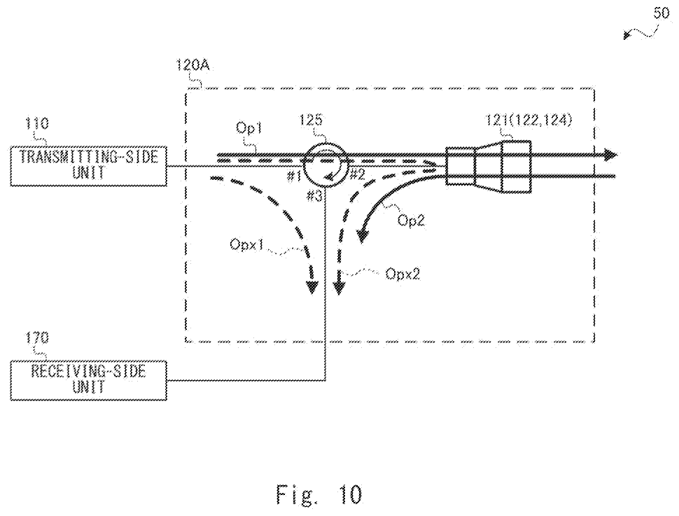

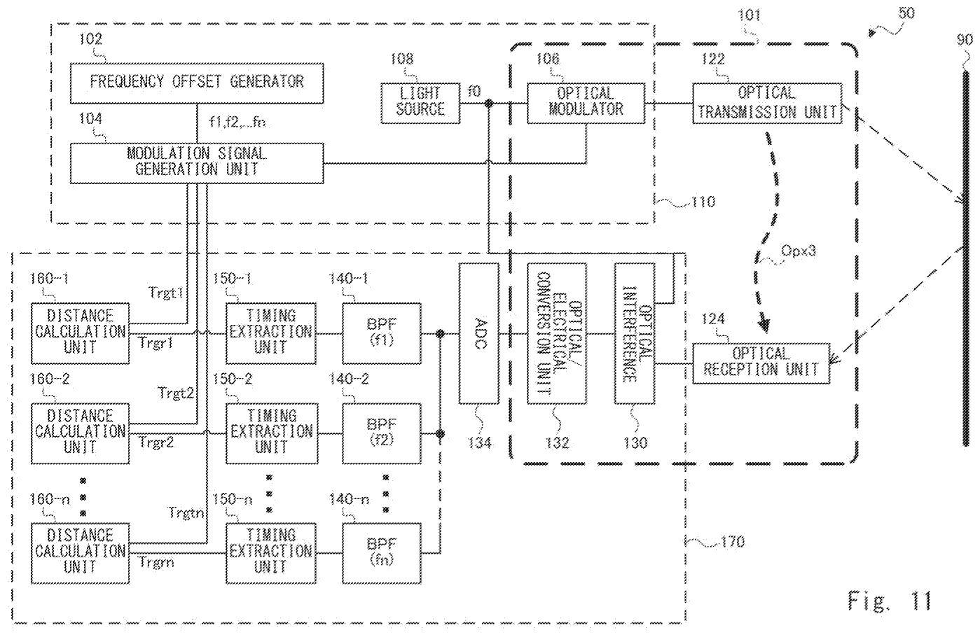

FIGS. 10 and 11 are diagrams showing a configuration in a case of miniaturizing the distance-measurement apparatus. FIG. 10 shows an example in which the optical transmission unit 122 and the optical reception unit 124 are integrally configured. FIG. 11 shows an example in which the optical transmission unit 122 and the optical reception unit 124 are integrated.

The distance-measurement apparatus 50 shown in FIG. 10 includes the transmitting-side unit 110, the receiving-side unit 170, and an optical transmission/reception apparatus 120A. The optical transmission/reception apparatus 120A includes an optical transceiver 121 and a circulator 125. Note that a transmission/reception coaxial optical system can be configured by the optical transceiver 121 and the circulator 125.

The optical transceiver 121 transmits a transmission pulse (transmitted light Op1) and receives a reflected pulse (received light Op2). It can be said that the optical transmission unit 122 and the optical reception unit 124 are integrally configured in the optical transceiver 121. Since the optical transmission unit 122 and the optical reception unit 124 are integrally configured as described above, the distance-measurement apparatus 50 can be miniaturized. Furthermore, a light transmission direction and a light reception direction can be coaxial with each other in the optical transceiver 121. Therefore, as the optical transceiver 121 is used, it is not necessary to adjust an optical axis between the optical transmission unit and the optical reception unit.

The circulator 125 is connected to the transmitting-side unit 110 (the optical modulator 106), the optical transceiver 121, and the receiving-side unit 170 (the optical interference unit 130). Specifically, the transmitting-side unit 110 is connected to a port #1 of the circulator 125, the optical transceiver 121 is connected to a port #2, and the receiving-side unit 170 is connected to a port #3. Note that the circulator 125 is configured to transmit a signal only in a direction determined between the ports. Specifically, the circulator 125 is configured to transmit a signal (light) input to the port #1 to the port #2, transmit a signal (light) input to the port #2 to the port #3, and transmit a signal (light) input to the port #3 to the port #1. Therefore, the circulator 125 is configured to output a transmission pulse (transmitted light Op1) output from the transmitting-side unit 110 (the optical modulator 106) to the optical transceiver 121. Further, the circulator 125 is configured to output a reflected pulse (received light Op2) received by the optical transceiver 121 to the receiving-side unit 170.

Note that the circulator 125 may exhibit vulnerability in performance. In this case, a signal may be transmitted in a direction different from that of the transmission of a signal in a predetermined direction between the ports described above. Due to such imperfections (vulnerability in performance) of the circulator 125, for example, a signal (light) input to the port #1 may be erroneously transmitted to the port #3. In this case, a transmission pulse output from the transmitting-side unit 110 (optical modulator 106) may be directly transmitted to the receiving-side unit 170 as leakage light Opx1.

In addition, transmitted light output from the port #2 of the circulator 125 may be reflected not on the distance-measurement-target object 90 but on a transmission end (a lens or the like) of the optical transceiver 121. In this case, transmission end reflected light Opx2 which is reflected light of the transmitted light reflected on the transmission end of the optical transceiver 121 may be transmitted to the receiving-side unit 170. As described above, in the example shown in FIG. 10, there is a possibility of light spillage from a transmitting side to a receiving side, such as the leakage light Opx1 and the transmission end reflected light Opx2.

The distance-measurement apparatus 50 shown in FIG. 11 includes an optical system integrated circuit 101. The optical system integrated circuit 101 can be implemented by, for example, a silicon photonics technique. The optical system integrated circuit 101 is one chip in which at least the optical transmission unit 122 and the optical reception unit 124 are integrated. In the optical system integrated circuit 101, not only the optical transmission unit 122 and the optical reception unit 124 but also the optical modulator 106, the optical interference unit 130, and the optical/electrical conversion unit 132 may be integrated. The optical system integrated circuit 101 can enable the miniaturization of the distance-measurement apparatus 50. Note that, by integrating the optical transmission unit 122 and the optical reception unit 124 into the optical system integrated circuit 101 which is one miniaturized chip, light output from the optical reception unit 124 may be directly transmitted as leakage light Opx3 to the optical reception unit 124. As described above, in the example shown in FIG. 11, there is a possibility of light spillage from the transmitting side to the receiving side, such as the leakage light Opx3.

The leakage light Opx1, the transmission end reflected light Opx2, and the leakage light Opx3 described above are collectively referred to as a crosstalk signal. The crosstalk signal is a signal that spills from the transmitting side (the transmitting-side unit 110 or the optical transmission unit 122) to the receiving side (the receiving-side unit 170 or the optical reception unit 124) without passing through the distance-measurement-target object 90. That is, the crosstalk signal is a signal directly spilling from the transmitting side (the transmitting-side unit 110 or the optical transmission unit 122) to the receiving side (the receiving-side unit 170 or the optical reception unit 124).

Note that since the transmitted optical signal is attenuated due to the reflection on the distance-measurement-target object 90 and through the flight process of the optical signal, power (power level) of the reflected pulse can decrease as the distance to the distance-measurement-target object 90 increases. On the other hand, the crosstalk signal is a signal transmitted only in the distance-measurement apparatus, and thus, there is a possibility that the crosstalk signal is not attenuated so much. Thus, power of the crosstalk signal can be much greater (for example, 1000 times) than the power of the reflected pulse.

In a case where a crosstalk signal is generated, the optical interference unit 130, the optical/electrical conversion unit 132, and the AD converter 134 can process the crosstalk signal similarly to a reflected pulse. Therefore, the optical interference unit 130 can detect a frequency offset of the crosstalk signal by using the optical signal having the frequency f0 from the light source 108 as reference light. The optical interference unit 130 can output optical signals having the frequencies f1, f2, . . . , and fn corresponding to the frequency offset of the crosstalk signal to the optical/electrical conversion unit 132.

Further, the optical/electrical conversion unit 132 can convert an optical signal corresponding to the crosstalk signal into an electric signal that is an analog signal. The AD converter 134 may convert an electric signal corresponding to the crosstalk signal into a digital signal. The electric signal corresponding to the crosstalk signal which has been obtained as the AD converter 134 has converted the analog signal into the digital signal can be output to the bandpass filters 140-1 to 140-n. Hereinafter, a problem in a case where the receiving-side unit 170 processes a crosstalk signal will be further described.

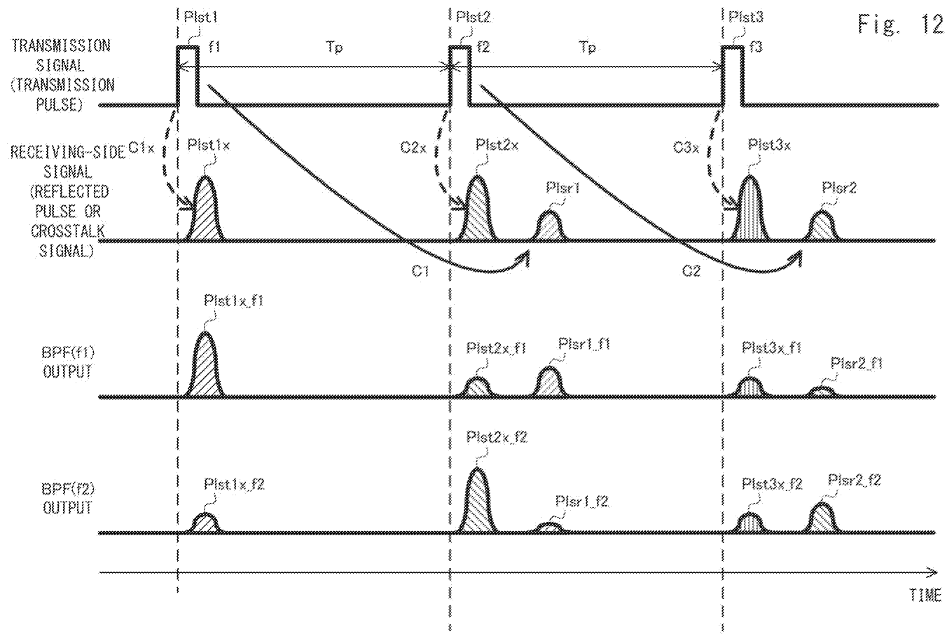

FIG. 12 is a timing chart in a case of miniaturizing the distance-measurement apparatus in the second comparative example. FIG. 12 is a timing chart showing a relation among a transmission pulse, a receiving-side signal (a reflected pulse and a crosstalk signal), and an output signal of the bandpass filter 140. Note that FIG. 12 is a diagram for explaining a problem in a case where the receiving-side unit 170 processes a crosstalk signal. In the examples shown in FIG. 12, it is assumed that the transmission pulses Plst1, Plst2, and Plst3 are transmitted at the pulse period Tp. Furthermore, a signal transmitted on the receiving side (receiving-side unit 170) of the distance-measurement apparatus 50 is referred to as the receiving-side signal. The receiving-side signal may include a reflected pulse (reflected light) and a crosstalk signal as described later.

First, the transmission pulse Plst1 having the frequency offset f1 is transmitted. At this time, as indicated by an arrow C1, the reflected pulse Plsr1 having the frequency offset f1 is received by the receiving-side unit 170 and is transmitted therein. Further, a crosstalk signal Plst1x corresponding to the transmission pulse Plst1 is generated from the transmitting side to the receiving side as indicated by an arrow C1x immediately after the transmitting timing of the transmission pulse Plst1. Therefore, the crosstalk signal Plst1x is transmitted in the receiving-side unit 170 at a timing immediately after the transmitting timing of the transmission pulse Plst1.

Next, the transmission pulse Plst2 having the frequency offset f2 is transmitted. At this time, as indicated by an arrow C2, the reflected pulse Plsr2 having the frequency offset f2 is received by the receiving-side unit 170 and is transmitted therein. Further, a crosstalk signal Plst2x corresponding to the transmission pulse Plst2 is generated from the transmitting side to the receiving side as indicated by an arrow C2x immediately after the transmitting timing of the transmission pulse Plst2. Therefore, the crosstalk signal Plst2x is transmitted in the receiving-side unit 170 at a timing immediately after the transmitting timing of the transmission pulse Plst2.

Next, the transmission pulse Plst3 having the frequency offset f3 is transmitted. At this time, reflected pulse Plsr3 (not shown) having the frequency offset f3 is received by the receiving-side unit 170 and is transmitted therein. Further, a crosstalk signal Plst3x corresponding to the transmission pulse Plst3 is generated from the transmitting side to the receiving side as indicated by an arrow C3x immediately after the transmitting timing of the transmission pulse Plst3. Therefore, the crosstalk signal Plst3x is transmitted in the receiving-side unit 170 at a timing immediately after the transmitting timing of the transmission pulse Plst3.

The bandpass filter 140-1 corresponding to the frequency f1 outputs a filtered signal Plst1x_f1 corresponding to the crosstalk signal Plst1x at a timing at which the crosstalk signal Plst1x is generated. The filtered signal Plst1x_f1 has the frequency f1. Furthermore, the bandpass filter 140-1 outputs a filtered signal Plsr1_f1 corresponding to the reflected pulse Plsr1 at a timing at which the reflected pulse Plsr1 is received. The filtered signal Plsr1_f1 has the frequency f1.

Further, the bandpass filter 140-2 corresponding to the frequency f2 outputs a filtered signal Plst2x_f2 corresponding to the crosstalk signal Plst2x at a timing at which the crosstalk signal Plst2x is generated. The filtered signal Plst2x_f2 has the frequency f2. Furthermore, the bandpass filter 140-2 outputs a filtered signal Plsr2_f2 corresponding to the reflected pulse Plsr2 at a timing at which the reflected pulse Plsr2 is received. The filtered signal Plsr2_f2 has the frequency f2.

Note that harmonic components of the transmission signal Plst1 can include, albeit to a small extent, a frequency component (the frequency offset f2, f3, or the like) other than the frequency offset f1. Therefore, harmonics of the crosstalk signal Plst1x can include, albeit to a small extent, a frequency component (the frequency offset f2, f3, or the like) other than the frequency offset f1. Similarly, harmonic components of the transmission signal Plst2 may include, albeit to a small extent, a frequency component (the frequency offset f1, f3, or the like) other than the frequency offset f2. Therefore, harmonic components of the crosstalk signal Plst2x can include, albeit to a small extent, a frequency component (the frequency offset f1, f3, or the like) other than the frequency offset f2. The same applies to the crosstalk signal Plst3x. The same applies to a reflected pulse (Plsr1 or Plsr2). Therefore, the bandpass filter 140 may not be able to completely separate a crosstalk signal (and a reflected pulse) depending on a frequency offset.

Therefore, the bandpass filter 140-1 can output a filtered signal Plst2x_f1 corresponding to the crosstalk signal Plst2x at a timing at which the crosstalk signal Plst2x is generated. Similarly, the bandpass filter 140-1 can output a filtered signal Plst3x_f1 corresponding to the crosstalk signal Plst3x at a timing at which the crosstalk signal Plst3x is generated. Furthermore, the bandpass filter 140-1 can output a filtered signal Plsr2_f1 corresponding to the reflected pulse Plsr2 at a timing at which the reflected pulse Plsr2 is received. The filtered signals Plst2x_f1, Plst3x_f1, and Plsr2_f1 have the frequency f1.

Furthermore, the bandpass filter 140-2 can output a filtered signal Plst1x_f2 corresponding to the crosstalk signal Plst1x at a timing at which the crosstalk signal Plst1x is generated. Similarly, the bandpass filter 140-2 can output a filtered signal Plst3x_f2 corresponding to the crosstalk signal Plst3x at a timing at which the crosstalk signal Plst3x is generated. Furthermore, the bandpass filter 140-2 can output a filtered signal Plsr1_f2 corresponding to the reflected pulse Plsr1 at a timing at which the reflected pulse Plsr1 is received. The filtered signals Plst1x_f2, Plst3x_f2, and Plsr1_f2 have the frequency f2.

As described above, there is a possibility that the bandpass filter 140-1 outputs not only the filtered signal Plsr1_f1 corresponding to the reflected pulse Plsr1 but also filtered signals corresponding to other signals (the crosstalk signal, the reflected pulse Plsr2, and the like). Therefore, there is a possibility that the timing extraction unit 150-1 also extracts a receiving timing of a signal (receiving-side signal) other than the receiving timing of the reflected pulse Plsr1 to be extracted originally. That is, there is a possibility that the timing extraction unit 150-1 outputs a measurement stop trigger corresponding to the crosstalk signal Plst1x or the crosstalk signal Plst2x before outputting the measurement stop trigger Trgr1 corresponding to the reflected pulse Plsr1. That is, there is a possibility that the timing extraction unit 150-1 outputs a measurement stop trigger corresponding to the filtered signal Plst1x_f1 or the filtered signal Plst2x_f1. Therefore, there is a possibility that the distance calculation unit 160-1 performs incorrect distance measurement.

Similarly, there is a possibility that the bandpass filter 140-2 outputs not only the filtered signal Plsr2_f2 corresponding to the reflected pulse Plsr2 but also filtered signals corresponding to other signals (the crosstalk signal, the reflected pulse Plsr1, and the like). Therefore, there is a possibility that the timing extraction unit 150-2 also extracts a receiving timing of a signal (receiving-side signal) other than the receiving timing of the reflected pulse Plsr2 to be extracted originally. That is, there is a possibility that the timing extraction unit 150-2 outputs a measurement stop trigger corresponding to the crosstalk signal Plst1x or the crosstalk signal Plst2x before outputting the measurement stop trigger Trgr2 corresponding to the reflected pulse Plsr2. That is, there is a possibility that the timing extraction unit 150-2 outputs a measurement stop trigger corresponding to the filtered signal Plst1x_f2 or the filtered signal Plst2x_f2. Therefore, there is a possibility that the distance calculation unit 160-2 performs incorrect distance measurement.

Note that the bandpass filter 140-1 can output Plsr2_f1 corresponding to the reflected pulse Plsr2 as described above. Similarly, the bandpass filter 140-2 can output Plsr1_f2 corresponding to the reflected pulse Plsr1. However, as described above, the power of a reflected pulse is originally small. Therefore, such a filtered signal by a reflected pulse corresponding to a frequency offset different from a frequency corresponding to the bandpass filter 140 can be ignored. On the other hand, since the power of a crosstalk signal is large, there is a possibility that the crosstalk signal cannot be ignored. Therefore, there is a possibility that incorrect distance measurement as described above is performed in a case of miniaturizing the apparatus.

On the other hand, the distance-measurement apparatus 1 according to the present example embodiment is configured to perform processing of invalidating the distance calculation processing performed by the distance calculation unit 10 for a certain period based on the transmitting timing of the transmission pulses. As a result, the distance-measurement apparatus 1 according to the present example embodiment can prevent incorrect distance measurement caused by the above-described crosstalk signal. Therefore, the distance-measurement apparatus 1 according to the present example embodiment can prevent incorrect distance measurement even in a case of miniaturizing the apparatus. In addition, the distance-measurement method executed by the distance-measurement apparatus 1 can also prevent incorrect distance measurement.

### First Example Embodiment

Next, a first example embodiment will be described.

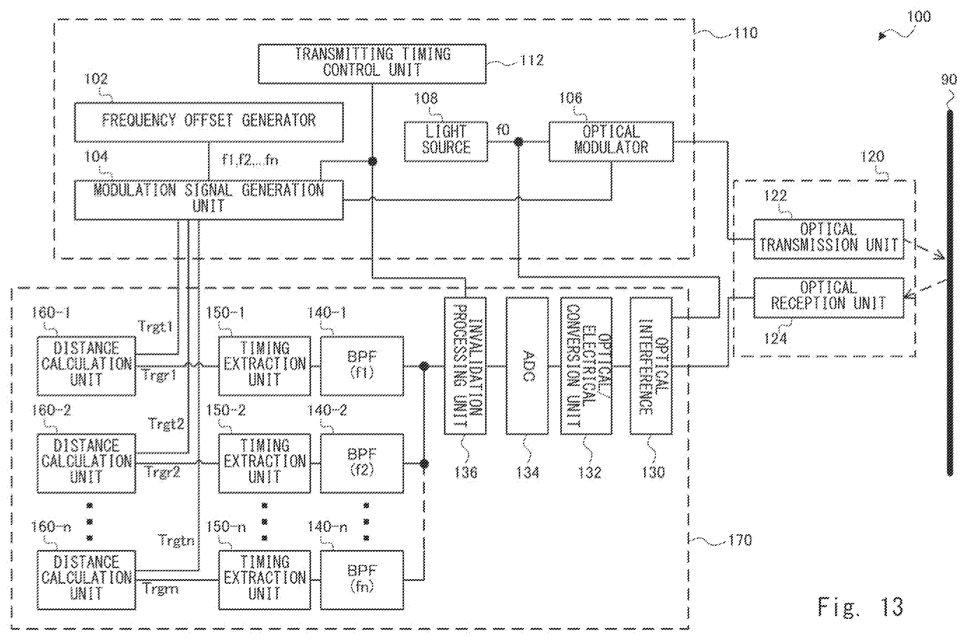

FIG. 13 is a diagram showing a configuration of a distance-measurement apparatus 100 according to the first example embodiment. The distance-measurement apparatus 100 according to the first example embodiment includes, as a transmitting-side module, a frequency offset generator 102, a modulation signal generation unit 104, an optical modulator 106, a light source 108, a transmitting timing control unit 112, and an optical transmission unit 122. The frequency offset generator 102, the modulation signal generation unit 104, the optical modulator 106, the light source 108, and the transmitting timing control unit 112 constitute a transmitting-side unit 110. The transmitting-side unit 110 functions as a pulse generation unit that generates a plurality of transmission pulses having frequency offsets different from each other. The transmitting-side unit 110 (pulse generation unit) corresponds to the generation unit 2 shown in FIG. 1. Furthermore, the optical transmission unit 122 corresponds to the transmission unit 4 shown in FIG. 1. Note that the functions of the frequency offset generator 102, the modulation signal generation unit 104, the optical modulator 106, the light source 108, and the optical transmission unit 122 in the transmitting-side module are substantially similar to those shown in FIG. 6, and thus, a description thereof is omitted as appropriate.

Furthermore, the distance-measurement apparatus 100 according to the first example embodiment includes, as a receiving-side module, an optical reception unit 124, an optical interference unit 130, an optical/electrical conversion unit 132, an AD converter 134, and an invalidation processing unit 136. The optical reception unit 124 corresponds to the reception unit 6 shown in FIG. 1. Further, the optical interference unit 130 corresponds to the detection unit 8 shown in FIG. 1. The invalidation processing unit 136 corresponds to the invalidation processing unit 12 shown in FIG. 1.

Furthermore, the optical transmission unit 122 and the optical reception unit 124 constitute an optical transmission/reception unit 120. The optical transmission/reception unit 120 may have the configuration of the optical transmission/reception apparatus 120A shown in FIG. 10. Alternatively, the optical transmission/reception unit 120 (the optical transmission unit 122 and the optical reception unit 124) may be formed in the optical system integrated circuit 101 as shown in FIG. 11. As described later in a fourth example embodiment, the optical transmission/reception unit 120 may measure a three-dimensional shape of a distance-measurement-target object 90 while sweeping (scanning) an emission direction of transmitted light. As a result, it is possible to acquire point cloud data indicating a position of each point of the distance-measurement-target object 90 (that is, the three-dimensional shape of the distance-measurement-target object 90).

Furthermore, the distance-measurement apparatus 100 according to the first example embodiment includes, as a receiving-side module, bandpass filters 140-1 to 140-n, timing extraction units 150-1 to 150-n, and distance calculation units 160-1 to 160-n. The distance calculation units 160-1 to 160-n correspond to the distance calculation unit 10 shown in FIG. 1. In addition, the optical interference unit 130, the optical/electrical conversion unit 132, the AD converter 134, the invalidation processing unit 136, the bandpass filter 140, the timing extraction unit 150, and the distance calculation unit 160 constitute a receiving-side unit 170. Note that the functions of the optical reception unit 124, the optical interference unit 130, the optical/electrical conversion unit 132, the AD converter 134, the bandpass filter 140, the timing extraction unit 150, and the distance calculation unit 160 in the receiving-side module are substantially similar to those shown in FIG. 6, and thus, a description thereof is omitted as appropriate.

The transmitting timing control unit 112 has a function as transmitting timing control means. The transmitting timing control unit 112 can be implemented by, for example, an arithmetic circuit such as an FPGA or a microcomputer. The transmitting timing control unit 112 controls a transmitting timing of a transmission pulse (transmitted light). Specifically, the transmitting timing control unit 112 controls a transmitting timing of a transmission pulse according to a transmission interval ΔT between transmission of the transmission pulse and transmission of the next transmission pulse.

More specifically, the transmitting timing control unit 112 generates a transmission trigger serving as a trigger for transmitting a transmission pulse every time the transmission interval ΔT elapses. Note that, in the first example embodiment, the transmitting timing control unit 112 generates a transmission trigger serving as a trigger for transmitting a transmission pulse every time a certain transmission interval ΔT0 elapses. Since a transmitting timing exists for each transmission interval ΔT, it can be said that the transmitting timing control unit 112 generates a transmission trigger serving as a trigger for transmitting a transmission pulse at a transmitting timing. In a case where the transmission interval ΔT is constant, the transmission interval ΔT (ΔT0) can correspond to the above-described pulse period Tp.

Then, the transmitting timing control unit 112 outputs a transmission trigger to the modulation signal generation unit 104 at a transmitting timing of a transmission pulse (that is, every time the transmission interval ΔT elapses). In this case, the modulation signal generation unit 104 may generate a modulation signal at a timing at which the transmission trigger is received. The transmitting timing control unit 112 may output a transmission trigger to the frequency offset generator 102 at a transmitting timing of a transmission pulse. In this case, the frequency offset generator 102 may output frequency offset information to the modulation signal generation unit 104 at a timing at which the transmission trigger is received. Then, the modulation signal generation unit 104 may generate a modulation signal according to the frequency offset information received from the frequency offset generator 102. In this manner, the transmitting timing control unit 112 controls a transmitting timing of a transmission pulse. Further, the transmitting timing control unit 112 outputs a transmission trigger to the invalidation processing unit 136 at a transmitting timing of a transmission pulse.

The invalidation processing unit 136 has a function as invalidation processing means. The invalidation processing unit 136 can be implemented by, for example, an arithmetic circuit such as an FPGA or a microcomputer. The invalidation processing unit 136 invalidates a digital signal (receiving-side signal) output from the AD converter 134 for a certain period from a timing at which a transmission trigger is received.

Specifically, the invalidation processing unit 136 performs mask processing on a digital signal output from the AD converter 134 for a certain period from a timing at which a transmission trigger is received. For example, the invalidation processing unit 136 may perform processing of setting a level (power) of a digital signal output from the AD converter 134 to 0 for a certain period from a timing at which a transmission trigger is received. Alternatively, the invalidation processing unit 136 may perform processing of not outputting a digital signal output from the AD converter 134 to the subsequent stage (bandpass filter 140) for a certain period from a timing at which a transmission trigger is received. Alternatively, the invalidation processing unit 136 may perform processing of stopping the subsequent processing for a certain period from a timing at which a transmission trigger is received. In other words, the invalidation processing unit 136 may perform processing in such a manner that the subsequent processing is performed in a period excluding a certain period from a timing at which a transmission trigger is received.

Note that the “certain period” is a period determined in advance according to a structure of the distance-measurement apparatus 100. The “certain period” is determined according to an optical path length of a crosstalk signal and the speed of light in the distance-measurement apparatus 100. That is, the “certain period” may correspond to a value obtained by dividing the optical path length of the crosstalk signal by the speed of light. For example, in a case where the optical transmission/reception unit 120 is configured as in the example of FIG. 10, the “certain period” can be determined according to a distance from the optical modulator 106 to a circulator 125, a distance from the circulator 125 to the optical interference unit 130, and a distance from the circulator 125 to an optical transceiver 121. The “certain period” can be determined according to a longer one of an optical path length of leakage light Opx1 and an optical path length of transmission end reflected light Opx2. Furthermore, for example, in a case where the optical transmission/reception unit 120 is configured as in the example of FIG. 11, the “certain period” can be determined according to a distance from the optical transmission unit 122 to the optical reception unit 124 in the optical system integrated circuit 101. That is, the “certain period” can be determined according to an optical path length of leakage light Opx3.

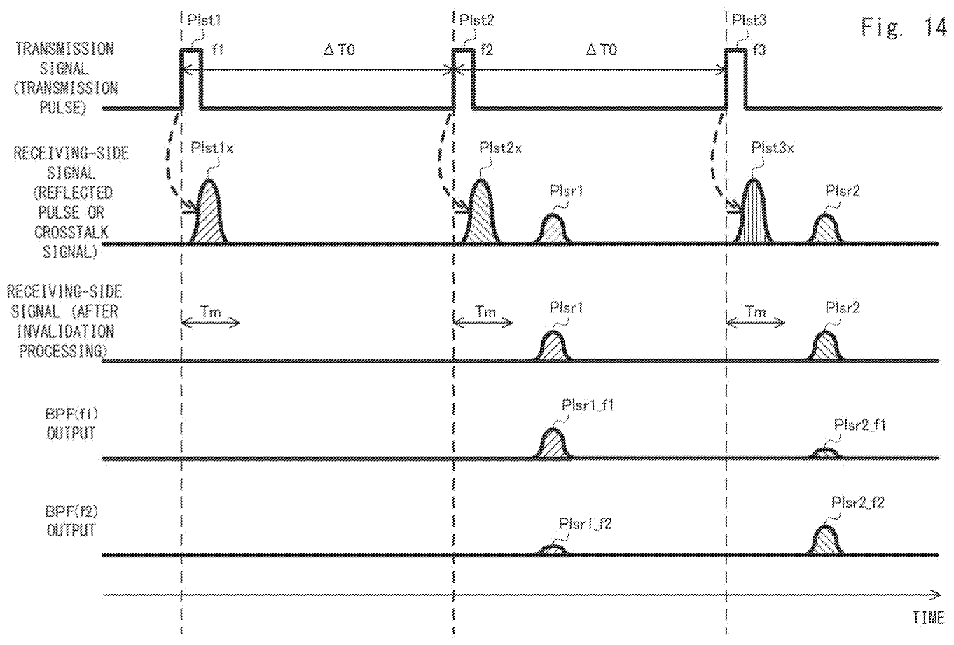

FIG. 14 is a timing chart showing a relation among a transmission pulse, a receiving-side signal, and an output signal of the bandpass filter 140 according to the first example embodiment. In the first example embodiment, transmission pulses are transmitted at a constant transmission interval ΔT0. That is, in the first example embodiment, the transmission interval ΔT0 corresponds to the above-described pulse period Tp. Therefore, a transmission pulse Plst2 having a frequency offset f2 is transmitted at a timing at which ΔT0 has elapsed after a transmission pulse Plst1 having a frequency offset f1 is transmitted. In addition, a transmission pulse Plst3 having a frequency offset f3 is transmitted at a timing at which ΔT0 has elapsed after the transmission pulse Plst2 having the frequency offset f2 is transmitted.

When the transmission pulse Plst1 having the frequency offset f1 is transmitted, a crosstalk signal Plst1x is transmitted in the receiving-side unit 170 at a timing immediately after a transmitting timing of the transmission pulse Plst1. In addition, when the transmission pulse Plst1 having the frequency offset f1 is transmitted, a reflected pulse Plsr1 having the frequency offset f1 is transmitted in the receiving-side unit 170. Note that, also in a case where the transmission pulse Plst2 having the frequency offset f2 is transmitted, a crosstalk signal and a reflected pulse (receiving-side signal) are transmitted in the receiving-side unit 170, similarly to the case shown in FIG. 12. In addition, also in a case where the transmission pulse Plst3 having the frequency offset f3 is transmitted, a crosstalk signal and a reflected pulse (receiving-side signal) are transmitted in the receiving-side unit 170, similarly to the case shown in FIG. 12.

Note that, in the first example embodiment, the invalidation processing unit 136 invalidates a receiving-side signal for a certain period Tm from a transmitting timing. Note that a crosstalk signal can be transmitted during the certain period Tm. Therefore, as shown in FIG. 14, the invalidation processing unit 136 invalidates a crosstalk signal. As a result, the bandpass filter 140 does not receive a signal corresponding to the crosstalk signal, and thus, the bandpass filter 140 does not output a signal corresponding to the crosstalk signal. Therefore, the output of the bandpass filter 140 can only correspond to a reflected pulse.

Therefore, the bandpass filter 140-1 outputs a filtered signal Plsr1_f1 corresponding to the reflected pulse Plsr1 and a filtered signal Plsr2_f1 corresponding to a reflected pulse Plsr2. Similarly, the bandpass filter 140-2 outputs a filtered signal Plsr1_f2 corresponding to the reflected pulse Plsr1 and a filtered signal Plsr2_f2 corresponding to the reflected pulse Plsr2. Therefore, the distance calculation unit 160 is more likely not to perform incorrect distance measurement caused by a crosstalk signal as described above. As described above, powers of the filtered signal Plsr2_f1 and the filtered signal Plsr1_f2 are very small. Therefore, the timing extraction unit 150 can ignore the filtered signal Plsr2_f1 and the filtered signal Plsr1_f2.

With such processing, the distance calculation unit 160-1 can perform distance measurement corresponding to the frequency offset f1 according to the filtered signal Plsr1_f1 corresponding to the reflected pulse Plsr1. Similarly, the distance calculation unit 160-2 can perform distance measurement corresponding to the frequency offset f2 according to the filtered signal Plsr2_f2 corresponding to the reflected pulse Plsr2. Therefore, the distance-measurement apparatus 100 according to the first example embodiment can prevent incorrect distance measurement even in a case where a crosstalk signal is generated.

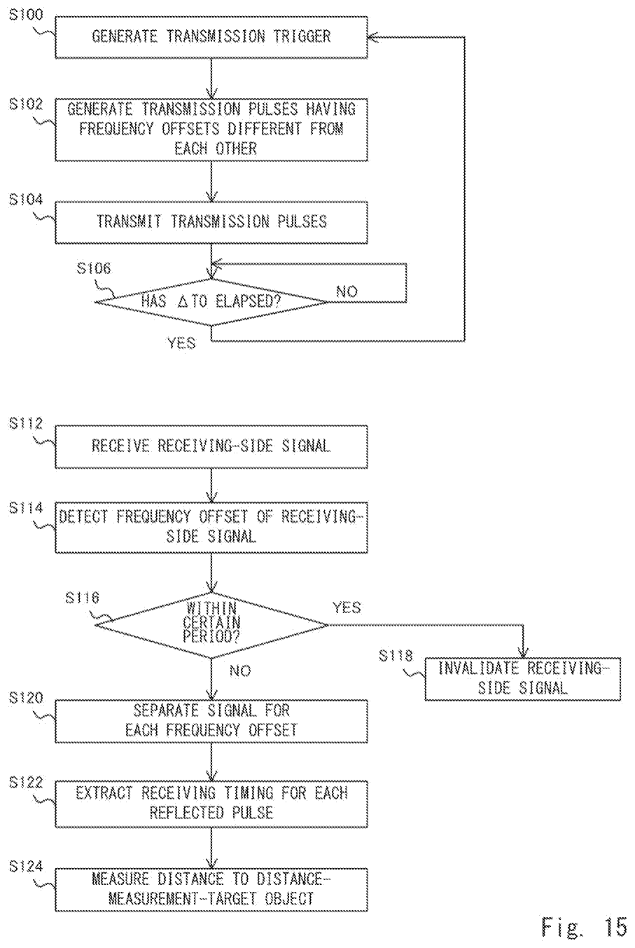

FIG. 15 is a flowchart showing a distance-measurement method executed by the distance-measurement apparatus 100 according to the first example embodiment. The processing of S100 to S106 is performed by the transmitting-side module, and the processing of S112 to S124 is performed by the receiving-side module. As described above, the transmitting timing control unit 112 generates a transmission trigger and transmits the generated transmission trigger to the modulation signal generation unit 104 and the invalidation processing unit 136 (step S100). As described above, the transmitting-side unit 110 generates transmission pulses having frequency offsets different from each other (step S102). The optical transmission unit 122 transmits (emits) an optical signal including transmission pulses generated in the processing of S102 to the distance-measurement-target object 90 (step S104).

Specifically, the optical modulator 106 of the transmitting-side unit 110 modulates an optical signal (modulator input signal) by using a modulation signal generated by the modulation signal generation unit 104 at a timing at which a transmission trigger is transmitted. As a result, the optical modulator 106 generates a plurality of transmission pulses having frequency offsets different from each other at a timing at which a transmission trigger is transmitted. Further, the optical transmission unit 122 transmits an optical signal including transmission pulses generated in the processing of S102 to the distance-measurement-target object 90 at a timing at which a transmission trigger is transmitted. In addition, by this processing, frequency offsets different from each other are applied to the respective transmission pulses at each timing at which a transmission trigger is transmitted. Note that a measurement start trigger Trgt corresponding to each transmission pulse can be output to the distance calculation unit 160 at a timing of S104.

The transmitting timing control unit 112 determines whether or not the transmission interval ΔT0 has elapsed from immediately previous transmission of a transmission pulse (step S106). In a case where the transmission interval ΔT0 has not elapsed (NO in S106), the transmitting timing control unit 112 repeats the processing of S106 and waits until the transmission interval ΔT0 elapses. Then, in a case where the transmission interval ΔT0 has elapsed (YES in S106), the processing flow returns to S100. That is, the transmitting timing control unit 112 generates a transmission trigger (S100).

The receiving-side unit 170 receives a receiving-side signal (step S112). As described above, the receiving-side signal may include not only a reflected pulse but also a crosstalk signal. In a case where the receiving-side signal is a reflected pulse, the optical reception unit 124 receives the reflected pulse, and the received reflected pulse is transmitted in the receiving-side unit 170. On the other hand, in a case where the receiving-side signal is a crosstalk signal, the crosstalk signal spills from the transmitting-side unit 110 to the receiving-side unit 170 and is transmitted in the receiving-side unit 170.

As described above, the optical interference unit 130 detects a frequency offset of a receiving-side signal (a reflected pulse or crosstalk signal) by using reference light (step S114). Note that, in a case where the current time point is within the certain period Tm from a transmitting timing (YES in step S116), the invalidation processing unit 136 invalidates the receiving-side signal as described above (step S118). Therefore, in a case where the receiving-side signal is a crosstalk signal, the crosstalk signal can be invalidated.

On the other hand, in a case where the current time point is not within the certain period Tm from a transmitting timing (NO in S116), the invalidation processing unit 136 does not invalidate the receiving-side signal. Therefore, in this case, the bandpass filter 140 (separation means) separates an optical signal for each frequency offset as described above (step S120). As a result, the optical signal is separated for each reflected pulse (receiving-side signal).

As described above, the timing extraction unit 150 extracts a receiving timing for each separated reflected pulse and outputs a measurement stop trigger Trgr at the extracted receiving timing (step S122). As described above, the distance calculation unit 160 calculates a distance R to the distance-measurement-target object 90 by using a measurement start trigger Trgt and a measurement stop trigger Trgr (step S124).

### Second Example Embodiment

Next, a second example embodiment will be described. The second example embodiment is different from the first example embodiment in that a transmission interval ΔT changes. Note that a configuration of a distance-measurement apparatus 100 according to the second example embodiment is substantially similar to that according to the first example embodiment. An operation of a transmitting timing control unit 112 according to the second example embodiment is different from the operation of the transmitting timing control unit 112 according to the first example embodiment. Operations of other components according to the second example embodiment are substantially similar to those of the first example embodiment, and thus a description thereof will be omitted.

In the second example embodiment, the transmitting timing control unit 112 performs control to change the transmission interval ΔT. As a result, the transmitting timing control unit 112 controls a transmitting timing of a transmission pulse. As a result, the transmission interval ΔT can be different for each transmission pulse. That is, the transmission interval ΔT becomes variable. In other words, a transmitting timing of the next transmission pulse after a certain transmission pulse is transmitted is variable. Similarly to the first example embodiment, the transmitting timing control unit 112 generates a transmission trigger serving as a trigger for transmitting a transmission pulse every time the transmission interval ΔT elapses. Then, the transmitting timing control unit 112 outputs a transmission trigger to a modulation signal generation unit 104 (or a frequency offset generator 102) and an invalidation processing unit 136 every time the transmission interval ΔT elapses.

The transmitting timing control unit 112 may perform control to change the transmission interval ΔT at a predetermined period as in a first example described later. That is, the transmission interval ΔT does not always need to be different for each transmission pulse. Furthermore, the transmitting timing control unit 112 may perform control to change the transmission interval ΔT for each transmission pulse according to a predetermined rule as in a second example described later. Furthermore, the transmitting timing control unit 112 may perform control to randomly change the transmission interval ΔT for each transmission pulse as in a third example described later. Note that the first example, the second example, and the third example are merely examples, and the transmitting timing control unit 112 may change the transmission period ΔT by another method.

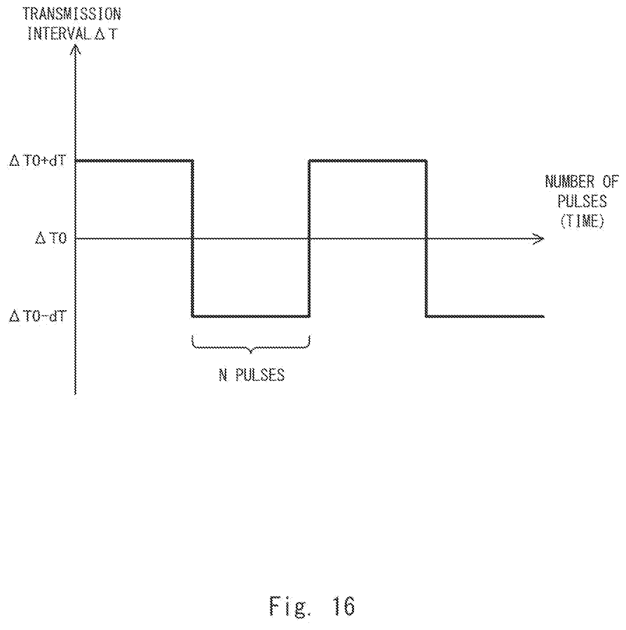

FIG. 16 is a diagram for explaining the first example of a method for changing the transmission interval ΔT according to the second example embodiment. FIG. 16 shows a relation between the transmission interval ΔT and the number of transmission pulses (the elapse of time). As shown in FIG. 16, in the first example, the transmission interval ΔT changes for every N transmission pulses. Note that N is an integer equal to or greater than one.

Specifically, first, the first N consecutive transmission pulses are transmitted at a transmission interval ΔT (ΔT=ΔT0+dT). Then, the next N consecutive transmission pulses are transmitted at a transmission interval ΔT (ΔT=ΔT0−dT). Then, the next N consecutive transmission pulses are transmitted at the transmission interval ΔT (ΔT=ΔT0+dT). Then, the next N consecutive transmission pulses are transmitted at the transmission interval ΔT (ΔT=ΔT0−dT). Similarly and subsequently, the transmission interval ΔT changes.

That is, a transmission interval ΔT when N consecutive transmission pulses are transmitted is constant (for example, ΔT0+dT), and a transmission interval ΔT when the next N consecutive transmission pulses are transmitted is constant (for example, ΔT0−dT). As described above, in the example shown in FIG. 16, the transmitting timing control unit 112 changes the transmission interval ΔT every predetermined period, that is, every period corresponding to a period during which N transmission pulses are transmitted. Therefore, in the example shown in FIG. 16, the transmission interval ΔT (transmitting timing) is alternately shifted for every N transmission pulses.

Note that the transmitting timing control unit 112 may determine the transmission period ΔT according to a function (a function indicating a relation between the number of pulses and the transmission period ΔT) corresponding to a waveform shown in FIG. 16. Alternatively, a lookup table indicating a correspondence relation between the order of transmission pulses and the transmission period ΔT as shown in FIG. 16 may be prepared in advance. In this case, the transmitting timing control unit 112 may determine the transmission period ΔT with reference to the lookup table.

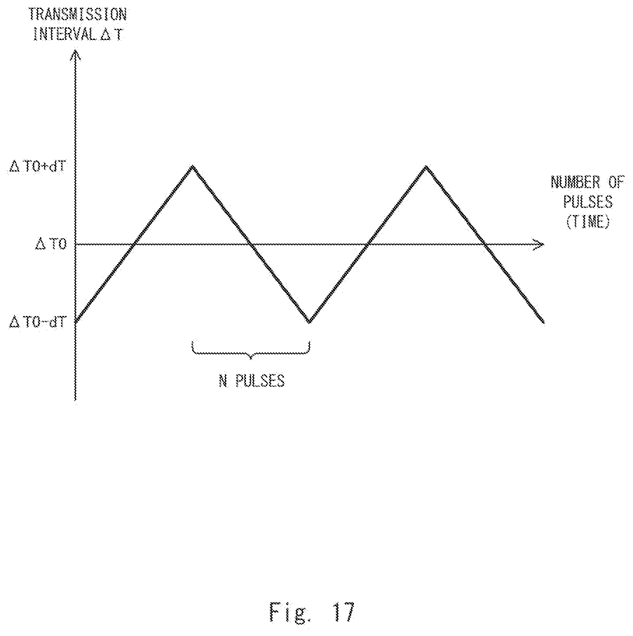

FIG. 17 is a diagram for explaining the second example of the method for changing the transmission interval ΔT according to the second example embodiment. FIG. 17 shows a relation between the transmission interval ΔT and the number of transmission pulses (the elapse of time). As shown in FIG. 17, in the second example, the transmission interval ΔT regularly changes for each transmission pulse. Then, a tendency of the change in transmission interval ΔT changes for every N transmission pulses.

Specifically, the transmitting timing control unit 112 gradually increases the transmission period ΔT from ΔT0−dT to ΔT+dT for the first N transmission pulses. For example, the transmitting timing control unit 112 increases the transmission period ΔT in proportion to the number of transmission pulses to be transmitted. Then, the transmitting timing control unit 112 gradually decreases the transmission period ΔT from ΔT0+dT to ΔT−dT for the next N transmission pulses. For example, the transmitting timing control unit 112 decreases the transmission period ΔT in proportion to the number of transmission pulses to be transmitted. Then, the transmitting timing control unit 112 gradually increases the transmission period ΔT from ΔT0−dT to ΔT+dT for the next N transmission pulses. Then, the transmitting timing control unit 112 gradually decreases the transmission period ΔT from ΔT0+dT to ΔT−dT for the next N transmission pulses. Similarly and subsequently, the transmission interval ΔT changes.

As described above, in the example shown in FIG. 17, the transmitting timing control unit 112 increases or decreases the transmission period ΔT for every N transmission pulses. That is, the transmitting timing control unit 112 performs control to change the transmission interval for each transmission pulse according to a predetermined rule. Therefore, in the example shown in FIG. 17, the transmission interval ΔT (transmitting timing) is shifted in a triangular waveform pattern for every N transmission pulses.

Note that the transmitting timing control unit 112 may determine the transmission period ΔT according to a function (a function indicating a relation between the number of pulses and the transmission period ΔT) corresponding to a waveform shown in FIG. 17. Alternatively, a lookup table indicating a correspondence relation between the order of transmission pulses and the transmission period ΔT as shown in FIG. 17 may be prepared in advance. In this case, the transmitting timing control unit 112 may determine the transmission period ΔT with reference to the lookup table.

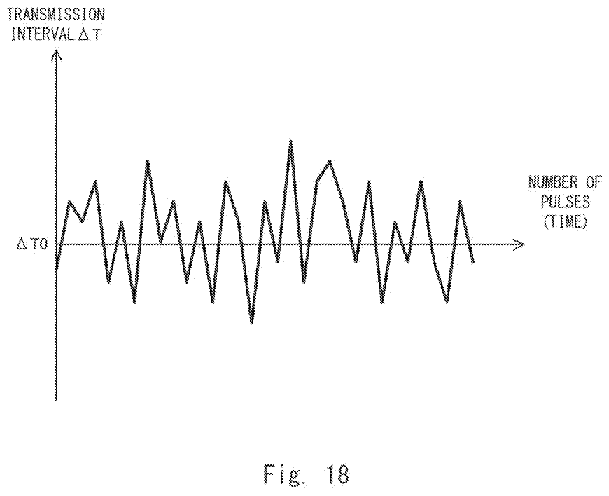

FIG. 18 is a diagram for explaining the third example of the method for changing the transmission interval ΔT according to the second example embodiment. FIG. 18 shows a relation between the transmission interval ΔT and the number of transmission pulses (the elapse of time). As shown in FIG. 18, in the third example, the transmission interval ΔT randomly changes for each transmission pulse.

The transmitting timing control unit 112 may determine the transmission period ΔT by using a random number generator. That is, the transmitting timing control unit 112 may determine the transmission period ΔT by using a random number (pseudo random number) output by inputting the number of transmission pulses transmitted so far to the random number generator. Alternatively, a lookup table indicating a correspondence relation between the order of a predetermined number (for example, 100) of transmission pulses and the randomly set transmission period ΔT may be prepared in advance. In this case, the transmitting timing control unit 112 may determine the transmission period ΔT with reference to the lookup table.

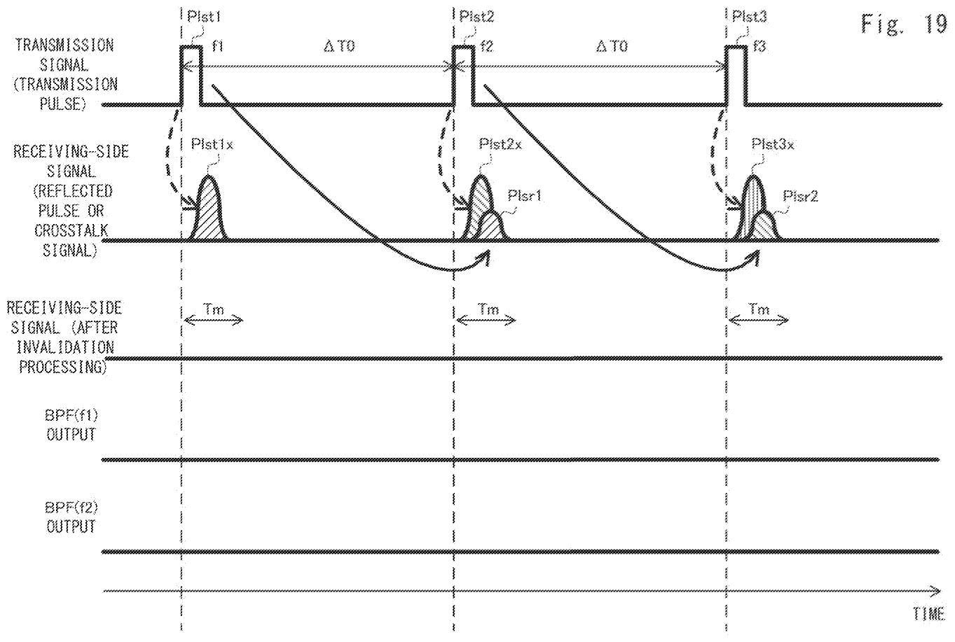

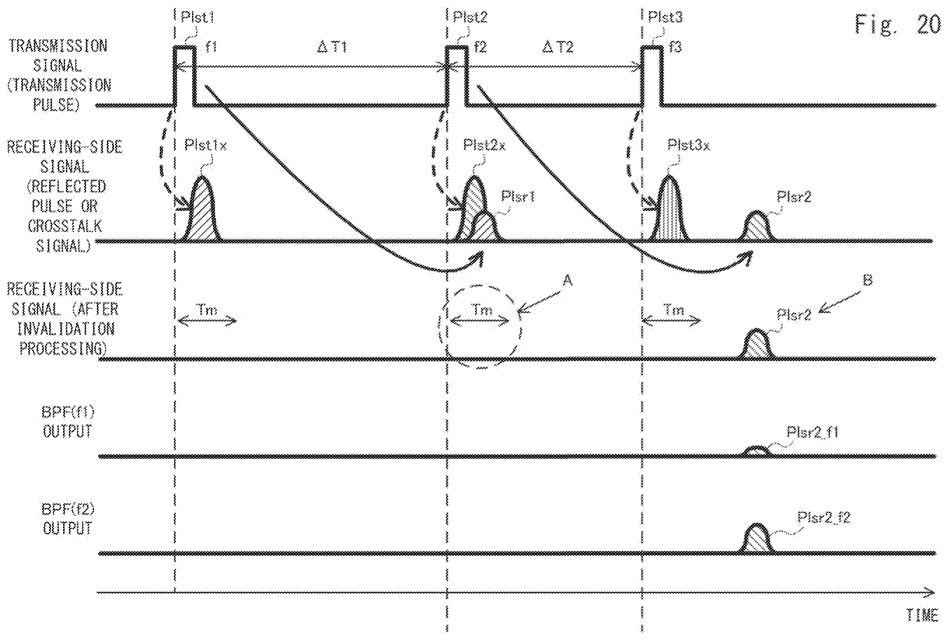

FIGS. 19 and 20 are diagrams for explaining effects of the characteristics according to the second example embodiment. FIG. 19 is a timing chart showing a relation among a transmission pulse, a receiving-side signal, and an output signal of a bandpass filter 140 according to the first example embodiment. In the example of FIG. 19, transmission pulses are transmitted at a constant transmission interval ΔT0. Furthermore, in the example of FIG. 19, it is assumed that a flight time Td from when a transmission pulse is transmitted to when the transmission pulse is reflected on the distance-measurement-target object 90 and returned to the distance-measurement apparatus 100 is substantially constant.

Note that the flight time Td of a transmission pulse may substantially coincide with the transmission interval ΔT between the transmission pulse and the next transmission pulse depending on a distance from the distance-measurement apparatus 100 to the distance-measurement-target object 90. In this case, as in the example of FIG. 19, a reflected pulse and a crosstalk signal of the next transmission pulse may overlap each other, and can be transmitted in the receiving-side unit 170 at the same timing. Hereinafter, such a phenomenon in which a timing at which a reflected pulse is received and a timing at which a crosstalk occurs overlap each other is referred to as “signal overlap”.

Specifically, in the example of FIG. 19, a timing at which a reflected pulse Plsr1 is received overlaps a timing at which a crosstalk signal Plst2x generated immediately after transmission of a transmission pulse Plst2 spills to the receiving-side unit 170. Similarly, a timing at which a reflected pulse Plsr2 is received overlaps a timing at which a crosstalk signal Plst3x generated immediately after transmission of a transmission pulse Plst3 spills to the receiving-side unit 170. In this case, when the invalidation processing unit 136 invalidates a receiving-side signal for the certain period Tm, not only a crosstalk signal but also a reflected pulse may be invalidated. Therefore, there is a possibility that a distance measurement result cannot be obtained.

Then, for example, in an application of measuring a three-dimensional shape or the like of a distance-measurement-target object by sweeping an emission direction of transmitted light, in a case where the distance-measurement-target object 90 is large to some extent and has a substantially flat shape, a distance from the distance-measurement apparatus 100 to the distance-measurement-target object 90 may be substantially constant. In this case, the flight time Td of a transmission pulse can be substantially constant. In this case, when the transmission interval ΔT is constant as in the first example embodiment, the above-described signal overlap may occur many times (continuously). In this case, a distance measurement result may not be able to be obtained many times. Then, in a case where point cloud data is generated by distance measurement performed multiple times while sweeping an emission direction of transmitted light, there is a possibility that data in the point cloud data is reduced.

FIG. 20 is a timing chart showing a relation among a transmission pulse, a receiving-side signal, and an output signal of the bandpass filter 140 according to the second example embodiment. In the example of FIG. 20, the transmission pulse Plst2 is transmitted at a timing at which a transmission interval ΔT1 has elapsed from a timing at which a transmission pulse Plst1 is transmitted. On the other hand, the transmission pulse Plst3 is transmitted at a timing at which a transmission interval ΔT2 has elapsed from a timing at which the transmission pulse Plst2 is transmitted. Note that ΔT1≠ΔT2.

In this case, even when a reflected pulse corresponding to a certain transmission pulse overlaps a crosstalk signal, a possibility that a reflected pulse corresponding to another transmission pulse does not overlap the crosstalk signal increases. Specifically, a timing at which the reflected pulse Plsr1 is received overlaps a timing at which the crosstalk signal Plst2x generated immediately after the transmission of the transmission pulse Plst2 spills to the receiving-side unit 170. On the other hand, a timing at which the reflected pulse Plsr2 is received does not overlap a timing at which the crosstalk signal Plst3x generated immediately after the transmission of the transmission pulse Plst3 spills to the receiving-side unit 170. In this case, when the invalidation processing unit 136 invalidates a receiving-side signal for the certain period Tm, the reflected pulse Plsr1 is invalidated together with the crosstalk signal Plst2x as indicated by an arrow A. On the other hand, the reflected pulse Plsr2 is not invalidated even in a case where the crosstalk signal Plst3x is invalidated as indicated by an arrow B. Therefore, distance measurement can be performed by using a filtered signal Plsr2_f2 corresponding to the reflected pulse Plsr2.

As described above, in the second example embodiment, the transmitting timing control unit 112 is configured to change the transmission interval ΔT. This makes it possible to prevent occurrence of the signal overlap as described above. Therefore, a reflected pulse is prevented from being invalidated together with a crosstalk signal, and thus, it is possible to prevent a distance measurement result from not being obtained many times. Therefore, the reduction of point cloud data can be prevented.

Furthermore, as in the first example described above, the transmitting timing control unit 112 may be configured to perform control to change the transmission interval ΔT at a predetermined period. With such a configuration, the transmitting timing control unit 112 according to the second example embodiment can be implemented with a simple circuit.

Furthermore, as in the second example described above, the transmitting timing control unit 112 may be configured to perform control to change the transmission interval ΔT for each transmission pulse according to a predetermined rule. With such a configuration, the transmitting timing control unit 112 according to the second example embodiment can be implemented with a simple circuit. Note that, in the first example described above, N consecutive pulses can be transmitted at a constant transmission interval ΔT (=ΔT0±dT), and thus, there is a possibility that the above-described signal overlap occurs continuously while the N consecutive pulses are transmitted. In particular, in a case where the speed of sweeping (a change amount per unit time in a transmission direction of a transmission pulse) of the distance-measurement apparatus 100 is low, such a situation can occur. In this case, the fact that a distance measurement result cannot be obtained can occur continuously.

On the other hand, since the transmitting timing control unit 112 according to the second example changes the transmission interval ΔT for each transmission pulse, it is possible to further prevent continuous occurrence of the signal overlap as compared with the first example. Therefore, it is possible to further prevent that a distance measurement result cannot be obtained continuously. Therefore, it is possible to further prevent the reduction of point cloud data.

Furthermore, as in the third example described above, the transmitting timing control unit 112 may be configured to perform control to randomly change the transmission interval ΔT for each transmission pulse. With such a configuration, it is possible to further prevent continuous occurrence of the signal overlap as compared with the first example and the second example. Therefore, it is possible to further prevent that a distance measurement result cannot be obtained continuously. That is, in a case where the shape of the distance-measurement-target object 90 corresponds to a shape of a triangular waveform shown in FIG. 17, even when the transmission interval ΔT is changed, the flight time Td may also change in the same manner as the change in transmission interval ΔT depending on the speed of sweeping and a distance to the distance-measurement-target object 90. In this case, there is a possibility that a distance measurement result cannot be obtained continuously. That is, even in the second example, a distance measurement result may not be able to be obtained many times, and point cloud data may be reduced.

On the other hand, a possibility that the random waveform shown in FIG. 18 corresponds to the shape of the distance-measurement-target object 90 is extremely low. Therefore, by randomly changing the transmission interval ΔT for each transmission pulse, it is possible to further prevent a possibility that a distance measurement result cannot be obtained continuously as compared with the second example. Therefore, it is possible to further prevent the reduction of point cloud data as compared with the second example.

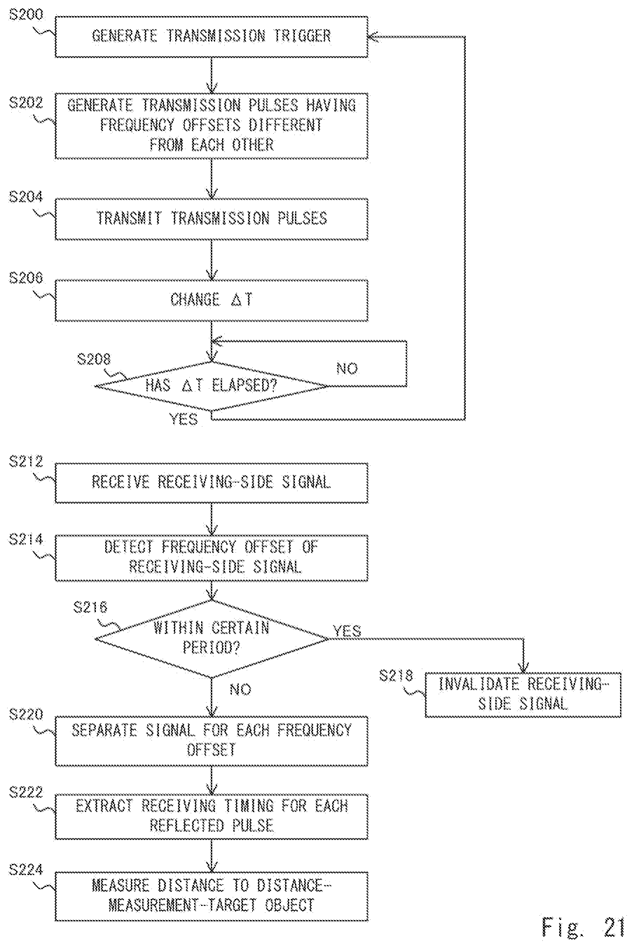

FIG. 21 is a flowchart showing a distance-measurement method executed by the distance-measurement apparatus 100 according to the second example embodiment. The processing of S200 to S208 is performed by a transmitting-side module, and the processing of S212 to S224 is performed by a receiving-side module. The transmitting timing control unit 112 generates a transmission trigger and transmits the generated transmission trigger to the modulation signal generation unit 104 and the invalidation processing unit 136 in a similar manner to the processing of S100 of FIG. 15 (step S200). A transmitting-side unit 110 generates transmission pulses having frequency offsets different from each other in a similar manner to the processing of S102 of FIG. 15 (step S202). An optical transmission unit 122 transmits (emits) an optical signal including the transmission pulses generated in the processing of S104 to the distance-measurement-target object 90 in a similar manner to the processing of S202 of FIG. 15 (step S204).

As described above, the transmitting timing control unit 112 changes the transmission interval ΔT (step S206). The transmitting timing control unit 112 determines whether or not the transmission interval ΔT has elapsed from immediately previous transmission of a transmission pulse (step S208). In a case where the transmission interval ΔT has not elapsed (NO in S208), the transmitting timing control unit 112 repeats the processing of S208 and waits until the transmission interval ΔT elapses. Then, in a case where the transmission interval ΔT has elapsed (YES in S208), the processing flow returns to S200. That is, the transmitting timing control unit 112 generates a transmission trigger (S200). As in the first example, the transmission interval ΔT does not have to be changed for each transmission pulse. Therefore, the processing of S206 does not need to be always performed. The processing of S206 may be performed after affirmative determination (YES) is made in the processing of S208.

The receiving-side unit 170 receives a receiving-side signal in a similar manner to the processing of S112 of FIG. 15 (step S212). The optical interference unit 130 detects a frequency offset of the receiving-side signal (a reflected pulse or a crosstalk signal) by using reference light in a similar manner to the processing of S114 of FIG. 15 (step S214). Note that, in a case where the current time point is within the certain period Tm from a transmitting timing (YES in step S216), the invalidation processing unit 136 invalidates the receiving-side signal in a similar manner to the processing of S118 of FIG. 15 (step S218). Therefore, in a case where the receiving-side signal is a crosstalk signal, the crosstalk signal can be invalidated.

On the other hand, in a case where the current time point is not within the certain period Tm from a transmitting timing (NO in S216), the invalidation processing unit 136 does not invalidate the receiving-side signal. Therefore, in this case, the bandpass filter 140 (separation means) separates an optical signal for each frequency offset in a similar manner to the processing of S120 of FIG. 15 (step S220). A timing extraction unit 150 extracts a receiving timing for each separated reflected pulse, and outputs a measurement stop trigger Trgr at the extracted receiving timing in a similar manner to the processing of S122 of FIG. 15 (step S222). A distance calculation unit 160 calculates a distance R to the distance-measurement-target object 90 by using a measurement start trigger Trgt and the measurement stop trigger Trgr in a similar manner to the processing of S124 of FIG. 15 (step S224).

### Third Example Embodiment

Next, a third example embodiment will be described. The third example embodiment is different from the second example embodiment in that a transmission interval ΔT (transmitting timing) is changed according to a distance measurement result. Note that, among components according to the third example embodiment, components substantially the same as the components in the first example embodiment are denoted by the same reference numerals. In the following description, a description of components substantially the same as the components in the first example embodiment will be omitted as appropriate.

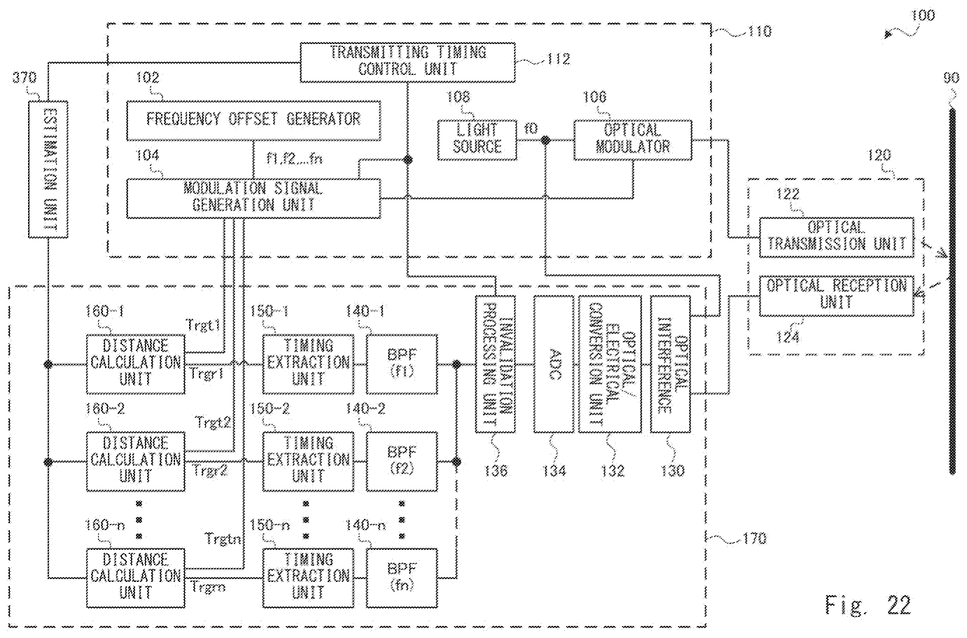

FIG. 22 is a diagram showing a configuration of a distance-measurement apparatus 100 according to the third example embodiment. The distance-measurement apparatus 100 according to the third example embodiment includes, as a transmitting-side module, a frequency offset generator 102, a modulation signal generation unit 104, an optical modulator 106, a light source 108, a transmitting timing control unit 112, and an optical transmission unit 122. The frequency offset generator 102, the modulation signal generation unit 104, the optical modulator 106, the light source 108, and the transmitting timing control unit 112 constitute a transmitting-side unit 110. Note that the functions of the frequency offset generator 102, the modulation signal generation unit 104, the optical modulator 106, the light source 108, and the optical transmission unit 122 in the transmitting-side module are substantially similar to those shown in FIG. 6, and thus, a description thereof is omitted as appropriate.

Furthermore, the distance-measurement apparatus 100 according to the third example embodiment includes, as a receiving-side module, an optical reception unit 124, an optical interference unit 130, an optical/electrical conversion unit 132, an AD converter 134, and an invalidation processing unit 136. Similarly to the first example embodiment, the optical transmission unit 122 and the optical reception unit 124 constitute an optical transmission/reception unit 120.

Furthermore, the distance-measurement apparatus 100 according to the third example embodiment includes, as a receiving-side module, bandpass filters 140-1 to 140-n, timing extraction units 150-1 to 150-n, and distance calculation units 160-1 to 160-n. In addition, the optical interference unit 130, the optical/electrical conversion unit 132, the AD converter 134, the invalidation processing unit 136, the bandpass filter 140, the timing extraction unit 150, and the distance calculation unit 160 constitute a receiving-side unit 170. Note that the functions of the receiving-side module are substantially similar to those shown in FIG. 6, and thus a description thereof will be omitted as appropriate. In addition, since the function of the invalidation processing unit 136 is substantially similar to that of the first example embodiment, a description thereof will be omitted as appropriate. Furthermore, the distance-measurement apparatus 100 according to the third example embodiment includes an estimation unit 370.

The transmitting timing control unit 112 according to the third example embodiment controls a transmitting timing based on a previously acquired distance measurement result. Specifically, the transmitting timing control unit 112 controls a transmitting timing according to the next distance measurement result estimated by the estimation unit 370 described later. More specifically, the transmitting timing control unit 112 controls a transmitting timing based on two or more distance measurement results acquired immediately before. Details will be described later.

The estimation unit 370 has a function as estimation means. The estimation unit 370 can be implemented by, for example, an arithmetic circuit such as an FPGA or a microcomputer. The estimation unit 370 estimates a distance measurement result (a distance to a distance-measurement-target object 90) to be acquired next based on a previously acquired distance measurement result. Specifically, the estimation unit 370 estimates a distance measurement result to be acquired next based on two or more distance measurement results acquired immediately before.

For example, the estimation unit 370 acquires immediately previous n (n is an integer equal to or greater than two) distance measurement results (distances). Then, the estimation unit 370 estimates the next distance measurement result by extrapolation from the n measurement results. Specifically, the estimation unit 370 applies n measurement results (distances obtained by distance measurement from the first time to the n-th time) to some kind of function (a graph with a horizontal axis representing a distance measurement order and a vertical axis representing a distance). For example, the estimation unit 370 plots distance data obtained in the first to n-th distance measurements on the graph with the horizontal axis representing the distance measurement order and the vertical axis representing the distance, and calculates a function corresponding to the plot. Then, the estimation unit 370 estimates a distance measurement result of the next distance measurement result (n+1-th) by using the function. For example, it is assumed that the next distance measurement is the M-th distance measurement, the (M−2)-th distance measurement result is 100 m, and the (M−1)-th distance measurement result is 101 m. In this case, since the distance measurement result increases by 1 m for each distance measurement (reception of a reflected pulse), the estimation unit 370 can estimate the M-th distance measurement result as 102 m.

As described above, when a receiving timing of a reflected pulse of a certain transmission pulse reflected on the distance-measurement-target object 90 coincides with a transmitting timing of the next transmission pulse, there is a possibility that a crosstalk signal of the next transmission pulse overlaps the reflected pulse on a receiving side. That is, there is a possibility that the above-described signal overlap occurs.

Therefore, the transmitting timing control unit 112 according to the third example embodiment controls a transmitting timing so as to prevent occurrence of the signal overlap. In other words, the transmitting timing control unit 112 determines the transmission interval ΔT so as to prevent occurrence of the signal overlap. Therefore, the transmitting timing control unit 112 determines a transmitting timing in such a manner that a timing at which a reflected pulse corresponding to an estimated distance measurement result is estimated to be received is different from the transmitting timing. In other words, the transmitting timing control unit 112 performs control in such a manner that a transmission pulse is transmitted at a timing other than a timing at which a reflected pulse corresponding to an estimated distance measurement result is estimated to be received. That is, the transmitting timing control unit 112 determines the transmission interval ΔT in such a manner that a time (flight time) from a transmitting timing of a transmission pulse corresponding to an estimated distance measurement result to a receiving timing of a reflected pulse corresponding to the transmission pulse does not coincide with the transmission interval ΔT.

Specifically, the transmitting timing control unit 112 acquires an estimation result from the estimation unit 370. The transmitting timing control unit 112 performs control so as not to transmit a transmission pulse at a timing corresponding to an estimated distance measurement result (a distance to the distance-measurement-target object 90). That is, the transmitting timing control unit 112 determines the transmission interval ΔT so that the transmission interval ΔT does not coincide with a flight time (estimated flight time Tdx) corresponding to an estimated distance measurement result. For example, the transmitting timing control unit 112 may determine the transmission interval ΔT so that ΔT=Tdx/2. Alternatively, in consideration of a certain period Tm, the transmitting timing control unit 112 may determine the transmission interval ΔT in such a manner that the sum of the transmission interval ΔT and the certain period Tm does not coincide with the estimated flight time Tdx.

As described above, the distance-measurement apparatus 100 according to the third example embodiment is configured to determine the transmission interval ΔT based on an estimated distance measurement result. This increases a possibility that the transmission interval ΔT does not coincide with the estimated flight time Tdx. Therefore, occurrence of the signal overlap can be prevented. Therefore, a reflected pulse is prevented from being invalidated at a timing at which the receiving side invalidates a receiving-side signal. That is, the invalidation processing unit 136 is prevented from invalidating a reflected pulse. Therefore, it is possible to prevent that a distance measurement result cannot be obtained.

Note that, in the second example embodiment, the transmission interval ΔT is changed regardless of a distance to the distance-measurement-target object 90. Therefore, there is a possibility that the flight time Td coincides with the changed transmission interval ΔT depending on a distance to the distance-measurement-target object 90. In such a case, there is a possibility that a distance measurement result cannot be obtained. On the other hand, in the third example embodiment, the transmission interval ΔT is determined based on an estimated distance measurement result, and thus, a possibility that the flight time Td coincides with the transmission interval ΔT is lower than that in the second example embodiment. Therefore, the configuration according to the third example embodiment further prevents invalidation of a reflected pulse at a timing at which a receiving-side signal is invalidated on the receiving side than the configuration according to the second example embodiment. Therefore, it is possible to further prevent that a distance measurement result cannot be obtained.

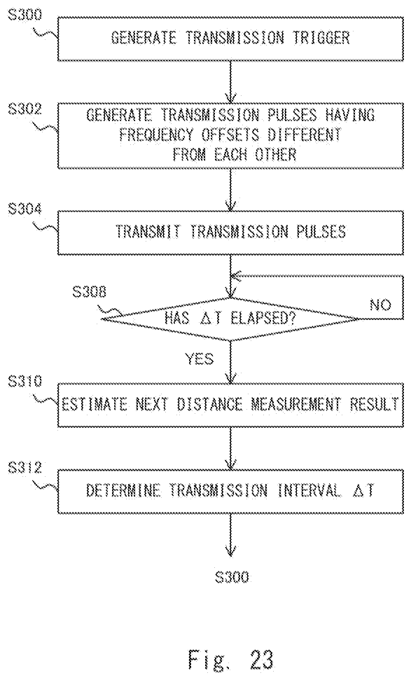

FIG. 23 is a flowchart showing a distance-measurement method executed by the distance-measurement apparatus 100 according to the third example embodiment. Note that processing performed by the receiving-side module is substantially similar to the processing of S212 to S224 of FIG. 21, and thus a description thereof is omitted.

The transmitting timing control unit 112 generates a transmission trigger and transmits the generated transmission trigger to the modulation signal generation unit 104 and the invalidation processing unit 136 in a similar manner to the processing of S200 of FIG. 21 (step S300). The transmitting-side unit 110 generates transmission pulses having frequency offsets different from each other in a similar manner to the processing of S202 of FIG. 21 (step S302). The optical transmission unit 122 transmits (emits) an optical signal including the transmission pulses generated in the processing of S204 to the distance-measurement-target object 90 in a similar manner to the processing of S302 of FIG. 21 (step S304).

The transmitting timing control unit 112 determines whether or not the transmission interval ΔT has elapsed from immediately previous transmission of a transmission pulse (step S308). In a case where the transmission interval ΔT has not elapsed (NO in S308), the transmitting timing control unit 112 repeats the processing of S308 and waits until a transmission interval ΔT0 elapses. Then, in a case where the transmission interval ΔT has elapsed (YES in S308), the estimation unit 370 estimates the next distance measurement result as described above (step S310). Then, as described above, the transmitting timing control unit 112 determines the transmission interval ΔT according to an estimated distance measurement result (step S312). Note that the processing of S310 does not need to be performed after the processing of S308. For example, the processing of S310 may be performed after the processing of S304.

### Fourth Example Embodiment

Next, a fourth example embodiment will be described. The fourth example embodiment is different from the third example embodiment in that a transmission interval ΔT (transmitting timing) is changed according to distance measurement information generated in advance and an emission direction of a transmission pulse. Note that, among components according to the fourth example embodiment, components substantially the same as the components in the first example embodiment are denoted by the same reference numerals. In the following description, a description of components substantially the same as the components in the first example embodiment will be omitted as appropriate.

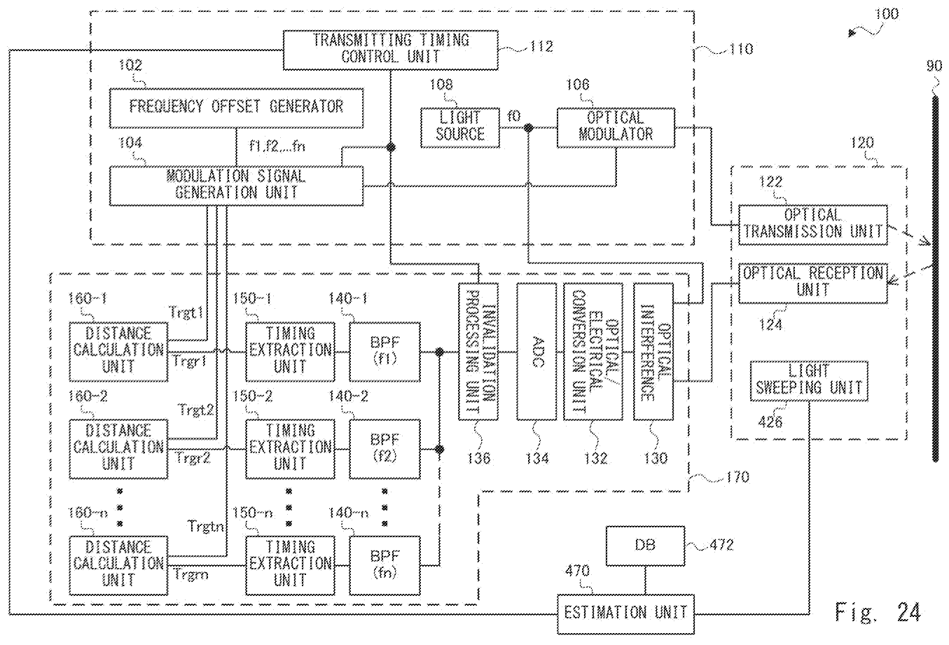

FIG. 24 is a diagram showing a configuration of a distance-measurement apparatus 100 according to the fourth example embodiment. The distance-measurement apparatus 100 according to the fourth example embodiment includes, as a transmitting-side module, a frequency offset generator 102, a modulation signal generation unit 104, an optical modulator 106, a light source 108, a transmitting timing control unit 112, and an optical transmission unit 122. The frequency offset generator 102, the modulation signal generation unit 104, the optical modulator 106, the light source 108, and the transmitting timing control unit 112 constitute a transmitting-side unit 110. Note that the functions of the frequency offset generator 102, the modulation signal generation unit 104, the optical modulator 106, the light source 108, and the optical transmission unit 122 in the transmitting-side module are substantially similar to those shown in FIG. 6, and thus, a description thereof is omitted as appropriate.

Furthermore, the distance-measurement apparatus 100 according to the fourth example embodiment includes, as a receiving-side module, an optical reception unit 124, an optical interference unit 130, an optical/electrical conversion unit 132, an AD converter 134, and an invalidation processing unit 136. Furthermore, the distance-measurement apparatus 100 according to the fourth example embodiment includes a light sweeping unit 426. The optical transmission unit 122, the optical reception unit 124, and the light sweeping unit 426 constitute an optical transmission/reception unit 120.

The light sweeping unit 426 has a function as light sweeping means. The light sweeping unit 426 sweeps (scans) a transmission pulse (transmitted light) toward a distance-measurement-target object 90 (i.e., the light sweeping unit 426 sweeps (scans) a distance-measurement-target object 90 with a transmission pulse (transmitted light)). Furthermore, the light sweeping unit 426 is configured to adjust a direction (an azimuth angle and an elevation angle) in which distance measurement is performed. That is, the light sweeping unit 426 adjusts a direction in which a transmission pulse is emitted. The light sweeping unit 426 can be implemented by, for example, a micro electro mechanical systems (MEMS) mirror.

Furthermore, the distance-measurement apparatus 100 according to the fourth example embodiment includes, as a receiving-side module, bandpass filters 140-1 to 140-n, timing extraction units 150-1 to 150-n, and distance calculation units 160-1 to 160-n. In addition, the optical interference unit 130, the optical/electrical conversion unit 132, the AD converter 134, the invalidation processing unit 136, the bandpass filter 140, the timing extraction unit 150, and the distance calculation unit 160 constitute a receiving-side unit 170. Note that the functions of the receiving-side module are substantially similar to those shown in FIG. 6, and thus a description thereof will be omitted as appropriate. In addition, since the function of the invalidation processing unit 136 is substantially similar to that of the first example embodiment, a description thereof will be omitted as appropriate.

Furthermore, the distance-measurement apparatus 100 according to the fourth example embodiment includes an estimation unit 470 and a database 472. Furthermore, the distance-measurement apparatus 100 according to the fourth example embodiment measures a distance to a predetermined distance-measurement-target object 90, for example. For example, the fourth example embodiment can be applied to a case where the distance-measurement apparatus 100 is used for monitoring a predetermined target object (the distance-measurement-target object 90).

The transmitting timing control unit 112 according to the fourth example embodiment controls transmitting timings based on a previously acquired distance measurement result. Specifically, the transmitting timing control unit 112 controls a transmitting timing according to the next distance measurement result estimated by the estimation unit 470 described later. More specifically, the transmitting timing control unit 112 controls a transmitting timing based on information generated in advance and in which a sweeping direction (i.e., an irradiation direction) and a distance measurement result in the sweeping direction are associated with each other. Details will be described later.

The estimation unit 470 has a function as estimation means. The estimation unit 470 can be implemented by, for example, an arithmetic circuit such as an FPGA or a microcomputer. In addition, the database 472 has a function as distance measurement information storage means. The database 472 stores distance measurement information in which a sweeping direction and a distance measurement result in the sweeping direction are associated with each other. The distance measurement information can be generated by measuring a distance to the distance-measurement-target object 90 in advance.

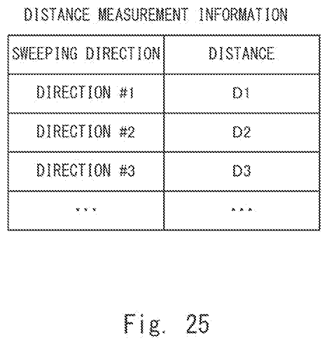

FIG. 25 is a diagram showing distance measurement information stored in the database 472 according to the fourth example embodiment. In the distance measurement information, a sweeping direction is associated with a distance measurement result (distance) obtained when a transmission pulse is emitted in the sweeping direction. The sweeping direction indicates, for example, an azimuth angle and an elevation angle. In the example of FIG. 25, for example, a distance measurement result obtained in a case where the sweeping direction is a direction #1 is a distance D1. A distance measurement result obtained in a case where the sweeping direction is a direction #2 is a distance D2. Note that the distance measurement information may be generated using a distance measurement result obtained in advance by the distance-measurement apparatus 100.

The estimation unit 470 acquires a direction (sweeping direction) in which a transmission pulse is emitted next from the light sweeping unit 426. The estimation unit 470 estimates the next distance measurement result by using the acquired sweeping direction and the distance measurement information stored in the database 472. Specifically, the estimation unit 470 estimates a distance corresponding to the next sweeping direction in the distance measurement information as the next distance measurement result. For example, in a case where the next sweeping direction is the direction #1, the estimation unit 470 estimates that the next distance measurement result is the distance D1. Furthermore, in a case where the next sweeping direction is a direction between the direction #1 and the direction #2, the estimation unit 470 may estimate a distance between the distance D1 and the distance D2 as the next distance measurement result. In this case, the estimation unit 470 may estimate the next distance measurement result by interpolation.

Similarly to the third example embodiment, the transmitting timing control unit 112 controls a transmitting timing so as to prevent occurrence of signal overlap. In other words, the transmitting timing control unit 112 determines the transmission interval ΔT so as to prevent occurrence of the signal overlap. Therefore, similarly to the third example embodiment, the transmitting timing control unit 112 determines the transmission interval ΔT so that a flight time corresponding to an estimated distance measurement result does not coincide with the transmission interval ΔT. Specifically, similarly to the third example embodiment, the transmitting timing control unit 112 acquires an estimation result from the estimation unit 470. Similarly to the third example embodiment, the transmitting timing control unit 112 performs control so as not to transmit a transmission pulse at a timing corresponding to an estimated distance measurement result (a distance to the distance-measurement-target object 90).

As described above, similarly to the third example embodiment, the distance-measurement apparatus 100 according to the fourth example embodiment is configured to determine the transmission interval ΔT based on an estimated distance measurement result. This increases a possibility that the transmission interval ΔT does not coincide with the estimated flight time Tdx. Therefore, a reflected pulse is prevented from being invalidated at a timing at which the receiving side invalidates a receiving-side signal. Therefore, it is possible to prevent that a distance measurement result cannot be obtained.

Note that the distance-measurement apparatus 100 according to the third example embodiment estimates the next distance measurement result by using a distance measurement result obtained immediately before. However, in this method, there is a possibility that distance measurement cannot be properly performed in a case where the next distance measurement result is different from a tendency of a change in distance measurement result obtained immediately before. That is, in a case where a direction in which a transmission pulse is emitted immediately before corresponds to an edge of the distance-measurement-target object 90, there is a possibility that the distance-measurement-target object 90 to which a transmission pulse was emitted immediately before does not exist in a direction in which a transmission pulse is to be emitted next. In such a case, there is a possibility that the next distance measurement result cannot be properly estimated from a distance measurement result obtained immediately before.

On the other hand, in a case where the distance-measurement-target object 90 is determined in advance, such as a case where the distance-measurement apparatus 100 is used to monitor a predetermined target object (distance-measurement-target object 90), it is possible to acquire in advance a distance measurement result previously obtained for the distance-measurement-target object 90. Then, the distance-measurement apparatus 100 according to the fourth example embodiment is configured to estimate the next distance measurement result by using distance measurement information generated from a distance measurement result acquired in advance. Therefore, it is possible to more accurately estimate a distance measurement result. Therefore, a possibility that a flight time Td coincides with the transmission interval ΔT is lower than that in the third example embodiment. Therefore, the configuration according to the fourth example embodiment further prevents invalidation of a reflected pulse at a timing at which a receiving-side signal is invalidated on the receiving side than the configuration according to the third example embodiment. Therefore, it is possible to further prevent that a distance measurement result cannot be obtained.

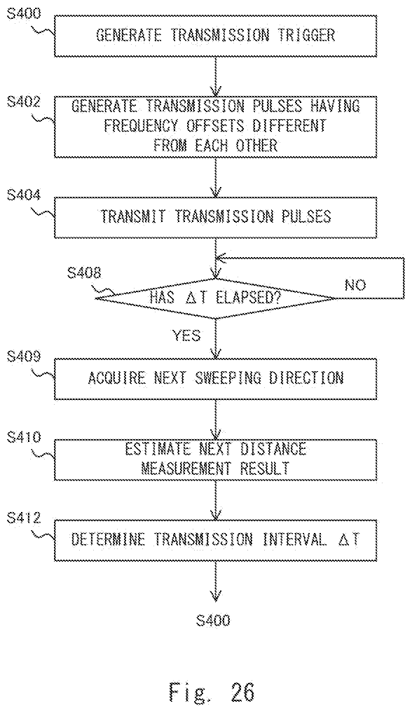

FIG. 26 is a flowchart showing a distance-measurement method executed by the distance-measurement apparatus 100 according to the fourth example embodiment. Note that processing performed by the receiving-side module is substantially similar to the processing of S212 to S224 of FIG. 21, and thus a description thereof is omitted.

The transmitting timing control unit 112 generates a transmission trigger and transmits the generated transmission trigger to the modulation signal generation unit 104 and the invalidation processing unit 136 in a similar manner to the processing of S200 and the like of FIG. 21 (step S400). The transmitting-side unit 110 generates transmission pulses having frequency offsets different from each other in a similar manner to the processing of S202 and the like of FIG. 21 (step S402). The optical transmission unit 122 transmits (emits) an optical signal including the transmission pulses generated in the processing of S204 and the like to the distance-measurement-target object 90 in a similar manner to the processing of S402 of FIG. 21 (step S404).

The transmitting timing control unit 112 determines whether or not the transmission interval ΔT has elapsed from immediately previous transmission of a transmission pulse (step S408). In a case where the transmission interval ΔT has not elapsed (NO in S408), the transmitting timing control unit 112 repeats the processing of S408 and waits until a transmission interval ΔT0 elapses. Then, in a case where the transmission interval ΔT has elapsed (YES in S408), the estimation unit 370 acquires the next sweeping direction as described above (step S409). Then, as described above, the estimation unit 370 estimates the next distance measurement result by using the next sweeping direction and the distance measurement information (step S410). Then, as described above, the transmitting timing control unit 112 determines the transmission interval ΔT according to an estimated distance measurement result (step S412). Note that the processing of S409 and S410 does not need to be performed after the processing of S408. For example, the processing of S409 and S410 may be performed after the processing of S404.

### Modified Example

Note that the present invention is not limited to the above-described example embodiments, and they may be modified as appropriate without departing from the spirit and scope of the present invention. For example, the order of the respective steps (processing) in the above-described flowchart can be changed as appropriate. Furthermore, one or more of the steps (processing) in the flowchart can be omitted as appropriate.

Further, the invalidation processing unit 136 may perform processing of invalidating a signal (receiving-side signal) transmitted from the optical transmission/reception unit 120 to the AD converter 134. Note that the signal transmitted from the optical transmission/reception unit 120 to the AD converter 134 is an analog signal, and it is more difficult to invalidate an analog signal than to invalidate a digital signal. Therefore, the invalidation processing unit 136 performs processing of invalidating a digital signal (receiving-side signal) output from the AD converter 134, thereby facilitating the processing and the circuit configuration.

Alternatively, the invalidation processing unit 136 may perform processing of invalidating a signal transmitted from the bandpass filter 140 to the distance calculation unit 160. Note that the signal transmitted from the bandpass filter 140 to the distance calculation unit 160 is transmitted through a different route for each frequency (frequency offset). Therefore, the invalidation processing unit 136 needs to perform processing for invalidating a receiving-side signal for each route different for each frequency. Therefore, the invalidation processing unit 136 performs processing of invalidating a receiving-side signal before being input to the bandpass filter 140 before an optical signal is separated, thereby facilitating the processing and the circuit configuration.

Furthermore, in the above-described example embodiments, the number of light sources is one, but the present invention is not limited to such a configuration. As disclosed in Patent Literature 1, a plurality of light sources may be provided. In the above-described example embodiments, a predetermined frequency offset is applied to a transmission pulse, but the present invention is not limited to such a configuration. As disclosed in Patent Literature 1, a frequency offset may be randomly set. Further, in the present example embodiment, a measurement start trigger signal and a measurement stop trigger signal are output to measure a flight time, but the present invention is not limited thereto. For example, any means capable of measuring a time difference between a transmission pulse and a reflected pulse corresponding to the transmission pulse, such as calculating a flight time from a position of a time-series data sample acquired by the AD converter, may be adopted. In addition, in the present example embodiment, a timing is extracted based on whether or not a signal exceeds a certain threshold in order to extract a timing of a reflected pulse, but the present invention is not limited thereto. For example, any means capable of measuring a temporal position of a reflected pulse, such as detecting a peak value of a signal and extracting a timing of a pulse, may be adopted.

Further, although, in the above-described example embodiments, the optical signal is separated for each of the frequency offsets of the reflected pulses by using a bandpass filter(s), the present invention is not limited to such a configuration. The signal may be separated by using a component(s) other than the bandpass filter. Further, if the receiving timing of the reflected pulse can be extracted for each frequency offset, the received optical signal does not need to be separated. However, by separating the optical signal for each of the frequency offsets of the reflected pulses by using the bandpass filter, it is possible to perform the distance-measurement processing at a high speed as described above. Further, by separating the optical signal for each of the frequency offsets of the reflected pulses by using the bandpass filter, the receiving timing of each reflected pulse can be easily extracted.

Further, the distance calculation unit 160 may take the processing time in the optical modulator 106 and the like into consideration when determining the timing at which the measurement start trigger is output. In other words, the distance calculation unit 160 may take account of the processing time from when the measurement start trigger is received to when the transmission pulse corresponding to the measurement start trigger is actually transmitted. In this case, the distance calculation unit 160 may use the timing that is obtained by adding the processing time in the optical modulator 106 and the like to the output timing of the measurement start trigger as the start timing of the distance measurement. Note that it is assumed that the processing time in the optical modulator 106 and the like is roughly constant.

Similarly, the distance calculation unit 160 may take the processing time of the optical interference unit 130 and the like until the measurement stop trigger is output into consideration when determining the measurement stop trigger. In other words, the distance calculation unit 160 may take account of the processing time from when the reflected pulse is received by the optical reception unit 124 to when the measurement stop trigger is output by the timing extraction unit 150. In this case, the distance calculation unit 160 may use the timing that is obtained by subtracting the processing time of the optical interference unit 130 and the like from the output timing of the measurement stop trigger as the end timing of the distance measurement. Note that it is assumed that the processing time in the optical interference unit 130 and the like is roughly constant.

Alternatively, the modulation signal generation unit 104 may output a measurement start trigger indicating a time at which the transmission pulse is transmitted while taking into account of the processing time until the transmission pulse is transmitted by the optical transmission unit 122 located in the subsequent stage. That is, when the time at which the modulation signal is generated is represented by t1 and the processing time in the optical modulator 106 and the like is represented by Δt1, the modulation signal generation unit 104 may output a measurement start trigger indicating a time (t1+Δt1). Similarly, the timing extraction unit 150 may output a measurement stop trigger indicating a time at which the reflected pulse is received while taking into account of the processing time in the optical interference unit 130 and the like located in the preceding stage. That is, when the time at which the timing extraction unit 150 receives a signal from the bandpass filter 140 is represented by t2 and the processing time in the optical interference unit 130 and the like is represented by Δt2, the timing extraction unit 150 may output a measurement stop trigger indicating a time (t2−Δt2). In this case, the distance calculation unit 160 may calculate the distance R, by using Expression 1, according to a relation Td=(t2−Δt2)−(t1+Δt1).

Furthermore, the transmitting timing control unit 112 may output a transmission trigger to the invalidation processing unit 136 while taking into account of the processing time in the modulation signal generation unit 104 and the optical modulator 106. That is, the transmitting timing control unit 112 may output a transmission trigger to the invalidation processing unit 136 after the processing time in the modulation signal generation unit 104 and the optical modulator 106 elapses from outputting of the transmission trigger to the modulation signal generation unit 104. Alternatively, the invalidation processing unit 136 may invalidate a receiving-side signal while taking into account of the processing time in the modulation signal generation unit 104 and the optical modulator 106. That is, the invalidation processing unit 136 may invalidate a receiving-side signal during the certain period Tm after a transmission trigger is received and the processing time in the modulation signal generation unit 104 and the optical modulator 106 elapses. Further, the invalidation processing unit 136 may invalidate a receiving-side signal while taking into account of the processing time in the optical interference unit 130 and the like. That is, the invalidation processing unit 136 may invalidate a receiving-side signal during the certain period Tm after a transmission trigger is received and the processing time in the optical interference unit 130 or the like elapses.

Furthermore, in the above-described example embodiment, the present example embodiment has been described as a hardware configuration, but the present example embodiment is not limited thereto. The present example embodiment can also be implemented by causing a central processing unit (CPU) to execute a computer program for at least one processing of each circuit in the distance-measurement apparatus.

The above-described program includes a command group (or software codes) for causing the computer to perform one or more functions that have been described in the example embodiments in a case where the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes propagated signals in electrical, optical, acoustic, or any other form.

Some or all of the above-described example embodiments can be described as in the following Supplementary Notes, but are not limited to the following Supplementary Notes.

### (Supplementary Note 1)

A distance-measurement apparatus including:
generation means for generating a plurality of transmission pulses of which a strength of an optical signal changes in a pulse-like manner, the plurality of transmission pulses having frequency offsets different from each other with respect to a reference frequency;
transmission means for repeatedly transmitting the generated transmission pulses;
reception means for receiving reflected pulses of the transmission pulses reflected on a distance-measurement-target object;
detection means for detecting frequency offsets of the received reflected pulses;
distance calculation means for calculating a distance to the distance-measurement-target object based on receiving timings of the received reflected pulses and transmitting timings of the transmission pulses corresponding to the frequency offsets detected from the reflected pulses; and
invalidation processing means for performing processing of invalidating distance calculation processing for a certain period based on the transmitting timings of the transmission pulses.

### (Supplementary Note 2)

The distance-measurement apparatus according to Supplementary Note 1, in which the invalidation processing means performs processing of invalidating the distance calculation processing by invalidating a receiving-side signal transmitted on a receiving side of the distance-measurement apparatus for a certain period of time based on the transmitting timings of the transmission pulses.

### (Supplementary Note 3)

The distance-measurement apparatus according to Supplementary Note 1 or 2, further including transmitting timing control means for controlling the transmitting timings by performing control to change a transmission interval from when a transmission pulse is transmitted to when a next transmission pulse is transmitted.

### (Supplementary Note 4)

The distance-measurement apparatus according to Supplementary Note 3, in which the transmitting timing control means performs control to change the transmission interval at a predetermined period.

### (Supplementary Note 5)

The distance-measurement apparatus according to Supplementary Note 3, in which the transmitting timing control means performs control to change the transmission interval for each of the transmission pulses according to a predetermined rule.

### (Supplementary Note 6)

The distance-measurement apparatus according to Supplementary Note 3, in which the transmitting timing control means performs control to randomly change the transmission interval for each of the transmission pulses.

### (Supplementary Note 7)

The distance-measurement apparatus according to Supplementary Note 3, in which the transmitting timing control means controls the transmitting timings based on a previously acquired distance measurement result.

### (Supplementary Note 8)

The distance-measurement apparatus according to Supplementary Note 7, further including estimation means for estimating a distance measurement result to be acquired next based on a previously acquired distance measurement result,
in which the transmitting timing control means determines the transmission interval in such a manner that a flight time from a transmitting timing of a transmission pulse to a receiving timing of a reflected pulse corresponding to the transmission pulse does not coincide with the transmission interval, the flight time corresponding to the estimated distance measurement result.

### (Supplementary Note 9)

The distance-measurement apparatus according to Supplementary Note 7 or 8, in which the transmitting timing control means controls the transmitting timings based on two or more distance measurement results acquired immediately before.

### (Supplementary Note 10)

The distance-measurement apparatus according to Supplementary Note 7 or 8, in which the transmitting timing control means controls the transmitting timings based on information generated in advance and in which a sweeping direction and a distance measurement result in the sweeping direction are associated with each other.

### (Supplementary Note 11)

The distance-measurement apparatus according to any one of Supplementary Notes 1 to 10, in which
the reception means receives an optical signal including the reflected pulses,
the distance-measurement apparatus further includes separation means for separating the received optical signal for each of the frequency offsets of the reflected pulses detected by the detection means, and
the distance calculation means calculates the distance to the distance-measurement-target object for each of the separated optical signals.

### (Supplementary Note 12)

The distance-measurement apparatus according to Supplementary Note 11, in which the invalidation processing means performs processing of invalidating the distance calculation processing by invalidating a receiving-side signal input to the receiving side before the optical signal is separated.

### (Supplementary Note 13)

A distance-measurement method including:
generating a plurality of transmission pulses of which a strength of an optical signal changes in a pulse-like manner, the plurality of transmission pulses having frequency offsets different from each other with respect to a reference frequency;
repeatedly transmitting the generated transmission pulses;
receiving reflected pulses of the transmission pulses reflected on a distance-measurement-target object;
detecting frequency offsets of the received reflected pulses;
calculating a distance to the distance-measurement-target object based on receiving timings of the received reflected pulses and transmitting timings of the transmission pulses corresponding to the frequency offsets detected from the reflected pulses; and
performing processing of invalidating distance calculation processing for a certain period based on the transmitting timings of the transmission pulses.

### (Supplementary Note 14)

The distance-measurement method according to Supplementary Note 13, in which processing of invalidating the distance calculation processing is performed by invalidating a receiving-side signal transmitted on a receiving side for a certain period of time based on the transmitting timings of the transmission pulses.

### (Supplementary Note 15)

The distance-measurement method according to Supplementary Note 13 or 14, in which the transmitting timings are controlled by performing control to change a transmission interval from when a transmission pulse is transmitted to when a next transmission pulse is transmitted.

### (Supplementary Note 16)

The distance-measurement method according to Supplementary Note 15, in which control is performed to change the transmission interval at a predetermined period.

### (Supplementary Note 17)

The distance-measurement method according to Supplementary Note 15, in which control is performed to change the transmission interval for each of the transmission pulses according to a predetermined rule.

### (Supplementary Note 18)

The distance-measurement method according to Supplementary Note 15, in which control is performed to randomly change the transmission interval for each of the transmission pulses.

### (Supplementary Note 19)

The distance-measurement method according to Supplementary Note 15, in which the transmitting timings are controlled based on a previously acquired distance measurement result.

### (Supplementary Note 20)

The distance-measurement method according to Supplementary Note 19, in which
a distance measurement result to be acquired next is estimated based on a previously acquired distance measurement result, and
the transmission interval is determined in such a manner that a flight time from a transmitting timing of a transmission pulse to a receiving timing of a reflected pulse corresponding to the transmission pulse does not coincide with the transmission interval, the flight time corresponding to the estimated distance measurement result.

### (Supplementary Note 21)

The distance-measurement method according to Supplementary Note 19 or 20, in which the transmitting timings are controlled based on two or more distance measurement results acquired immediately before.

### (Supplementary Note 22)

The distance-measurement method according to Supplementary Note 19 or 20, in which the transmitting timings are controlled based on information generated in advance and in which a sweeping direction and a distance measurement result in the sweeping direction are associated with each other.

### (Supplementary Note 23)

The distance-measurement method according to any one of Supplementary Notes 13 to 22, in which
an optical signal including the reflected pulses is received,
the received optical signal is separated for each of the frequency offsets of the detected reflected pulses, and
the distance to the distance-measurement-target object is calculated for each of the separated optical signals.

### (Supplementary Note 24)

The distance-measurement method according to Supplementary Note 23, in which processing of invalidating the distance calculation processing is performed by invalidating a receiving-side signal input to the receiving side before the optical signal is separated.

### REFERENCE SIGNS LIST

1 DISTANCE-MEASUREMENT APPARATUS
2 GENERATION UNIT
4 TRANSMISSION UNIT
6 RECEPTION UNIT
8 DETECTION UNIT
10 DISTANCE CALCULATION UNIT
12 INVALIDATION PROCESSING UNIT
50 DISTANCE-MEASUREMENT APPARATUS
90 DISTANCE-MEASUREMENT-TARGET OBJECT
100 DISTANCE-MEASUREMENT APPARATUS
101 OPTICAL SYSTEM INTEGRATED CIRCUIT
102 FREQUENCY OFFSET GENERATOR
104 MODULATION SIGNAL GENERATION UNIT
106 OPTICAL MODULATOR
108 LIGHT SOURCE
110 TRANSMITTING-SIDE UNIT
112 TRANSMITTING TIMING CONTROL UNIT
120 OPTICAL TRANSMISSION/RECEPTION UNIT
120A OPTICAL TRANSMISSION/RECEPTION APPARATUS
121 OPTICAL TRANSCEIVER
122 OPTICAL TRANSMISSION UNIT
124 OPTICAL RECEPTION UNIT
125 CIRCULATOR
130 OPTICAL INTERFERENCE UNIT
132 OPTICAL/ELECTRICAL CONVERSION UNIT
134 AD CONVERTER
136 INVALIDATION PROCESSING UNIT
140 BANDPASS FILTER
150 TIMING EXTRACTION UNIT
160 DISTANCE CALCULATION UNIT
170 RECEIVING-SIDE UNIT
370 ESTIMATION UNIT
426 LIGHT SWEEPING UNIT
470 ESTIMATION UNIT
472 DATABASE

What is claimed is:

1. A distance-measurement apparatus comprising:
generation circuit configured to generate a plurality of transmission pulses of which a strength of an optical signal changes in a pulse-like manner, the plurality of transmission pulses having frequency offsets different from each other with respect to a reference frequency;
transmission circuit configured to repeatedly transmit the generated transmission pulses;
reception circuit configured to receive reflected pulses of the transmission pulses reflected on a distance-measurement-target object;
detection circuit configured to detect frequency offsets of the received reflected pulses;
distance calculation circuit configured to calculate a distance to the distance-measurement-target object based on receiving timings of the received reflected pulses and transmitting timings of the transmission pulses corresponding to the frequency offsets detected from the reflected pulses; and
invalidation processing circuit configured to perform processing of invalidating distance calculation processing for a certain period based on the transmitting timings of the transmission pulses.

2. The distance-measurement apparatus according to claim 1, wherein the invalidation processing circuit performs processing of invalidating the distance calculation processing by invalidating a receiving-side signal transmitted on a receiving side of the distance-measurement apparatus for a certain period of time based on the transmitting timings of the transmission pulses.

3. The distance-measurement apparatus according to claim 1, further comprising transmitting timing control circuit configured to control the transmitting timings by performing control to change a transmission interval from when a transmission pulse is transmitted to when a next transmission pulse is transmitted.

4. The distance-measurement apparatus according to claim 3, wherein the transmitting timing control circuit performs control to change the transmission interval at a predetermined period.

5. The distance-measurement apparatus according to claim 3, wherein the transmitting timing control circuit performs control to change the transmission interval for each of the transmission pulses according to a predetermined rule.

6. The distance-measurement apparatus according to claim 3, wherein the transmitting timing control circuit performs control to randomly change the transmission interval for each of the transmission pulses.

7. The distance-measurement apparatus according to claim 3, wherein the transmitting timing control circuit controls the transmitting timings based on a previously acquired distance measurement result.

8. The distance-measurement apparatus according to claim 7, further comprising estimation circuit configured to estimate a distance measurement result to be acquired next based on a previously acquired distance measurement result,
wherein the transmitting timing control circuit determines the transmission interval in such a manner that a flight time from a transmitting timing of a transmission pulse to a receiving timing of a reflected pulse corresponding to the transmission pulse does not coincide with the transmission interval, the flight time corresponding to the estimated distance measurement result.

9. The distance-measurement apparatus according to claim 7, wherein the transmitting timing control circuit controls the transmitting timings based on two or more distance measurement results acquired immediately before.

10. The distance-measurement apparatus according to claim 7, wherein the transmitting timing control circuit controls the transmitting timings based on information generated in advance and in which a sweeping direction and a distance measurement result in the sweeping direction are associated with each other.

11. The distance-measurement apparatus according to claim 1, wherein
the reception circuit receives an optical signal including the reflected pulses,
the distance-measurement apparatus further comprises separation circuit configured to separate the received optical signal for each of the frequency offsets of the reflected pulses detected by the detection circuit, and
the distance calculation circuit calculates the distance to the distance-measurement-target object for each of the separated optical signals.

12. The distance-measurement apparatus according to claim 11, wherein the invalidation processing circuit performs processing of invalidating the distance calculation processing by invalidating a receiving-side signal input to the receiving side before the optical signal is separated.

13. A distance-measurement method comprising:
generating a plurality of transmission pulses of which a strength of an optical signal changes in a pulse-like manner, the plurality of transmission pulses having frequency offsets different from each other with respect to a reference frequency;
repeatedly transmitting the generated transmission pulses;
receiving reflected pulses of the transmission pulses reflected on a distance-measurement-target object;
detecting frequency offsets of the received reflected pulses;
calculating a distance to the distance-measurement-target object based on receiving timings of the received reflected pulses and transmitting timings of the transmission pulses corresponding to the frequency offsets detected from the reflected pulses; and
performing processing of invalidating distance calculation processing for a certain period based on the transmitting timings of the transmission pulses.

14. The distance-measurement method according to claim 13, wherein processing of invalidating the distance calculation processing is performed by invalidating a receiving-side signal transmitted on a receiving side for a certain period of time based on the transmitting timings of the transmission pulses.

15. The distance-measurement method according to claim 13, wherein the transmitting timings are controlled by performing control to change a transmission interval from when a transmission pulse is transmitted to when a next transmission pulse is transmitted.

16. The distance-measurement method according to claim 15, wherein control is performed to change the transmission interval at a predetermined period.

17. The distance-measurement method according to claim 15, wherein control is performed to change the transmission interval for each of the transmission pulses according to a predetermined rule.

18. The distance-measurement method according to claim 15, wherein control is performed to randomly change the transmission interval for each of the transmission pulses.

19. The distance-measurement method according to claim 15, wherein the transmitting timings are controlled based on a previously acquired distance measurement result.

20. The distance-measurement method according to claim 19, wherein
a distance measurement result to be acquired next is estimated based on a previously acquired distance measurement result, and
the transmission interval is determined in such a manner that a flight time from a transmitting timing of a transmission pulse to a receiving timing of a reflected pulse corresponding to the transmission pulse does not coincide with the transmission interval, the flight time corresponding to the estimated distance measurement result.

21.-24. (canceled)
